(19) United States
(12) Patent Application Publication
(10) Pub. No.: US 2026/0001375 A1
(43) Pub. Date: Jan. 1, 2026

(54) Wheel Performance Monitoring and Feedback System For Vehicle Control

(71) Applicant: Hutchinson S.A., Paris (FR)

(72) Inventors: Larry W. Stuck, Amherst, NY (US); N. Jared Keegan, Neddick, ME (US); Stanley Nomile, Needham, MA (US); Joseph B. Ferreira, Watertown, MA (US); Lars Johan Resare, Ewing, NJ (US); Scott Gregory Carlson, Reading, MA (US)

(21) Appl. No.: 19/260,815

(22) Filed: Jul. 7, 2025

Related U.S. Application Data
(63) Continuation of application No. 19/092,531, filed on Mar. 27, 2025.
(60) Provisional application No. 63/570,947, filed on Mar. 28, 2024.

(51) Int. Cl. B60C 23/00; G01M 17/02; G07C 5/02

(52) U.S. Cl. CPC B60C 23/002; B60C 23/003; G01M 17/02; G07C 5/02

(57) ABSTRACT

A system for monitoring wheel performance of a vehicle, the vehicle including a plurality of wheels and a plurality of tires mounted on the plurality of wheels. The system may include a plurality of sensors on the plurality of wheels and a controller operatively connected to the plurality of sensors. The controller may include at least one processor configured to: receive measurements from the plurality of sensors; determine, for each wheel of the plurality of wheels, based on the measurements from a sensor of the plurality of sensors on that wheel, an angular acceleration of that wheel; calculate, for each wheel of the plurality of wheels, based on the angular acceleration of that wheel, an angular jerk of that wheel; and determine, for each wheel of the plurality of wheels, based on the angular jerk of that wheel, an amount of tire slip for that wheel.

### CROSS REFERENCE TO RELATED APPLICATION

The present application is a continuation of U.S. patent application Ser. No. 19/092,531 filed Mar. 27, 2025, which claims the benefit of U.S. Patent Provisional Application Ser. No. 63/570,947, filed Mar. 28, 2024, the disclosures of which are hereby incorporated by reference in their entireties.

### BACKGROUND

### 1. Field

This disclosed subject matter relates generally to a system for monitoring wheel performance and, in some non-limiting embodiments or aspects, to a system for controlling vehicle traction by monitoring wheel mechanics and adjusting tire pressure without operator involvement.

### 2. Description of Related Art

Central tire inflation (CTI) systems are commonly used for certain vehicles such as trucks, tractors, military vehicles, and earth-moving vehicles. For example, CTI systems are installed in many military vehicles as they enable tire pressure to be lowered as needed to enable the user to benefit from the increased traction available while operating at low tire pressure. CTI systems are utilized to adjust tire pressure to provide vehicles with the versatility to maneuver over different terrain types and to reduce maintenance requirements. For example, the pressure of a vehicle tire may be lowered to provide additional traction for the vehicle when the vehicle travels on soft terrain such as sand or mud, or the tire pressure may be raised to reduce the rolling resistance of the vehicle when the vehicle travels on an asphalt road. CTI systems typically comprise a main fluid line for inflating and deflating the tire, a wheel valve for controlling the processes of inflating and deflating the vehicle tire, and a pilot fluid line for selectively opening and closing the wheel valve by applying a pilot pressure or a pilot pressure pulse to the wheel valve.

However, existing CTI systems require user interaction to adjust the tire pressure and do not monitor wheel performance in order to improve or optimize the tire pressure.

### SUMMARY

Accordingly, non-limiting embodiments or aspects of the present disclosure may provide systems that overcome some or all of the deficiencies of existing systems. For example, non-limiting embodiments or aspects of the present disclosure may provide a system to monitor wheel performance to enable a central tire inflation (CTI) system to adjust tire pressure based on the wheel performance without user interaction.

According to some non-limiting embodiments or aspects, provided is a system for monitoring wheel performance of a vehicle, the vehicle including a plurality of wheels and a plurality of tires mounted on the plurality of wheels, the system including: a plurality of sensors on the plurality of wheels; a controller operatively connected to the plurality of sensors, the controller including at least one processor configured to: receive measurements from the plurality of sensors on the plurality of wheels; determine, for each wheel of the plurality of wheels, based on the measurements from a sensor of the plurality of sensors on that wheel, an angular acceleration of that wheel; calculate, for each wheel of the plurality of wheels, based on the angular acceleration of that wheel, an angular jerk of that wheel; determine, for each wheel of the plurality of wheels, based on the angular jerk of that wheel, an amount of tire slip for that wheel; and perform at least one of the following: (i) control a display to display the amount of tire slip of at least one wheel of the plurality of wheels, (ii) control a central tire inflation system of the vehicle to inflate or deflate at least one tire of the plurality of tires mounted on the at least one wheel based on the amount of tire slip of the at least one wheel, or any combination thereof.

In some non-limiting embodiments or aspects, the controller including the at least one processor is further configured to: receive, from the vehicle, a current vehicle velocity; determine, for each wheel of the plurality of wheels, based on the current vehicle velocity, an angular velocity of that wheel, and a known effective wheel radius of that wheel, a wheel slip ratio of that wheel; and perform at least one of the following: (i) control the display to display the wheel slip ratio of the at least one wheel of the plurality of wheels, (ii) control the central tire inflation system of the vehicle to inflate or deflate the at least one tire of the plurality of tires mounted on the at least one wheel based on the wheel slip ratio of the at least one wheel, or any combination thereof.

In some non-limiting embodiments or aspects, the sensor includes at least one of an accelerometer, a gyrometer, or any combination thereof, and wherein the measurements comprise at least one of acceleration measurements obtained from the accelerometer, angular velocity measurements obtained from the gyrometer, or any combination thereof.

In some non-limiting embodiments or aspects, the system further includes: a plurality of central tire inflation valves associated with the plurality of wheels; and the central tire inflation system fluidically coupled to the plurality of wheels via a plurality of fluid lines and the plurality of central tire inflation valves.

In some non-limiting embodiments or aspects, the controller is operatively connected to each sensor of the plurality of sensors in one of a wireless configuration or a wired configuration.

In some non-limiting embodiments or aspects, a wheel of the plurality of wheels includes a circular rim having formed coaxially on opposite ends thereof outwardly flaring circumferential flange sections disposed to be engaged by beads of a tire mounted on the rim of the wheel, wherein the rim further includes intermediate the opposite ends thereof a transverse wall section extending transversely of an axis of the rim and having therethrough a central opening disposed coaxially of the axis of the rim, wherein a central tire inflation valve of the plurality of central tire inflation valves is secured to a side of the transverse wall section, and wherein the central tire inflation valve includes a pair of air inlet/outlet ducts.

In some non-limiting embodiments or aspects, a wheel of the plurality of wheels includes a two-piece wheel, and wherein the two-piece wheel includes an inner rim half and an outer rim half held together with fastening members.

According to some non-limiting embodiments or aspects, provided is a method for monitoring wheel performance of a vehicle, the vehicle including a plurality of wheels, a plurality of tires mounted on the plurality of wheels, and a plurality of sensors on the plurality of wheels, the method including: receiving, with at least one processor, measurements from the plurality of sensors on the plurality of wheels; determining, with the at least one processor, for each wheel of the plurality of wheels, based on the measurements from a sensor of the plurality of sensors on that wheel, an angular acceleration of that wheel; calculating, with the at least one processor, for each wheel of the plurality of wheels, based on the angular acceleration of that wheel, an angular jerk of that wheel; determining, with the at least one processor, for each wheel of the plurality of wheels, based on the angular jerk of that wheel, an amount of tire slip for that wheel; and performing, with the at least one processor, at least one of the following: (i) controlling a display to display the amount of tire slip of at least one wheel of the plurality of wheels, (ii) controlling a central tire inflation system of the vehicle to inflate or deflate at least one tire of the plurality of tires mounted on the at least one wheel based on the amount of tire slip of the at least one wheel, or any combination thereof.

In some non-limiting embodiments or aspects, the method further includes: receiving, with the at least one processor, from the vehicle, a current vehicle velocity; determining, with the at least one processor, for each wheel of the plurality of wheels, based on the current vehicle velocity, an angular velocity of that wheel, and a known effective wheel radius of that wheel, a wheel slip ratio of that wheel; and performing, with the at least one processor, at least one of the following: (i) controlling the display to display the wheel slip ratio of the at least one wheel of the plurality of wheels, (ii) controlling the central tire inflation system of the vehicle to inflate or deflate the at least one tire of the plurality of tires mounted on the at least one wheel based on the wheel slip ratio of the at least one wheel, or any combination thereof.

In some non-limiting embodiments or aspects, the sensor includes at least one of an accelerometer, a gyrometer, or any combination thereof, and wherein the measurements comprise at least one of acceleration measurements obtained from the accelerometer, angular velocity measurements obtained from the gyrometer, or any combination thereof.

In some non-limiting embodiments or aspects, the central tire inflation system is fluidically coupled to the plurality of wheels via a plurality of fluid lines and a plurality of central tire inflation valves associated with the plurality of wheels.

In some non-limiting embodiments or aspects, a controller including the at least one processor is operatively connected to each sensor of the plurality of sensors in one of a wireless configuration or a wired configuration.

In some non-limiting embodiments or aspects, a wheel of the plurality of wheels includes a circular rim having formed coaxially on opposite ends thereof outwardly flaring circumferential flange sections disposed to be engaged by beads of a tire mounted on the rim of the wheel, wherein the rim further includes intermediate the opposite ends thereof a transverse wall section extending transversely of an axis of the rim and having therethrough a central opening disposed coaxially of the axis of the rim, wherein a central tire inflation valve of the plurality of central tire inflation valves is secured to a side of the transverse wall section, and wherein the central tire inflation valve includes a pair of air inlet/outlet ducts.

In some non-limiting embodiments or aspects, a wheel of the plurality of wheels includes a two-piece wheel, and wherein the two-piece wheel includes an inner rim half and an outer rim half held together with fastening members.

According to some non-limiting embodiments or aspects, provided is a computer program product including at least one non-transitory computer-readable medium including program instructions for monitoring wheel performance of a vehicle, the vehicle including a plurality of wheels, a plurality of tires mounted on the plurality of wheels, and a plurality of sensors on the plurality of wheels, that, when executed by at least one processor, cause the at least one processor to: receive measurements from the plurality of sensors on the plurality of wheels; determine for each wheel of the plurality of wheels, based on the measurements from a sensor of the plurality of sensors on that wheel, an angular acceleration of that wheel; calculate, for each wheel of the plurality of wheels, based on the angular acceleration of that wheel, an angular jerk of that wheel; determine, for each wheel of the plurality of wheels, based on the angular jerk of that wheel, an amount of tire slip for that wheel; and perform at least one of the following: (i) controlling a display to display the amount of tire slip of at least one wheel of the plurality of wheels, (ii) controlling a central tire inflation system of the vehicle to inflate or deflate at least one tire of the plurality of tires mounted on the at least one wheel based on the amount of tire slip of the at least one wheel, or any combination thereof.

In some non-limiting embodiments or aspects, the program instructions, when executed by the at least one processor, further cause the at least one processor to: receive, from the vehicle, a current vehicle velocity; determine, for each wheel of the plurality of wheels, based on the current vehicle velocity, an angular velocity of that wheel, and a known effective wheel radius of that wheel, a wheel slip ratio of that wheel; and perform at least one of the following: (i) controlling the display to display the wheel slip ratio of the at least one wheel of the plurality of wheels, (ii) controlling the central tire inflation system of the vehicle to inflate or deflate the at least one tire of the plurality of tires mounted on the at least one wheel based on the wheel slip ratio of the at least one wheel, or any combination thereof.

In some non-limiting embodiments or aspects, the sensor includes at least one of an accelerometer, a gyrometer, or any combination thereof, and wherein the measurements comprise at least one of acceleration measurements obtained from the accelerometer, angular velocity measurements obtained from the gyrometer, or any combination thereof, and wherein the central tire inflation system is fluidically coupled to the plurality of wheels via a plurality of fluid lines and a plurality of central tire inflation valves associated with the plurality of wheels.

In some non-limiting embodiments or aspects, a controller including the at least one processor is operatively connected to each sensor of the plurality of sensors in one of a wireless configuration or a wired configuration.

In some non-limiting embodiments or aspects, a wheel of the plurality of wheels includes a circular rim having formed coaxially on opposite ends thereof outwardly flaring circumferential flange sections disposed to be engaged by beads of a tire mounted on the rim of the wheel, wherein the rim further includes intermediate the opposite ends thereof a transverse wall section extending transversely of an axis of the rim and having therethrough a central opening disposed coaxially of the axis of the rim, wherein a central tire inflation valve of the plurality of central tire inflation valves is secured to a side of the transverse wall section, and wherein the central tire inflation valve includes a pair of air inlet/outlet ducts.

In some non-limiting embodiments or aspects, a wheel of the plurality of wheels includes a two-piece wheel, and wherein the two-piece wheel includes an inner rim half and an outer rim half held together with fastening members.

According to some non-limiting embodiments or aspects, provided is a system for monitoring wheel performance of a vehicle, the vehicle including a plurality of wheels and a plurality of tires mounted on the plurality of wheels, the system including: a plurality of sensors on the plurality of wheels; a controller operatively connected to the plurality of sensors, the controller including at least one processor configured to: receive, for each wheel of the plurality of wheels, from a sensor of the plurality of sensors on that wheel, a strain measurement associated with that wheel; calculate, for each wheel of the plurality of wheels, based on the strain measurement associated with that wheel, a rate of strain change of that wheel; determine, for each wheel of the plurality of wheels, based on the rate of strain change, a maximum rate of strain change of that wheel and a minimum rate of strain change of that wheel; calculate, for each wheel of the plurality of wheels, based on the maximum rate of strain change and the minimum rate of strain change, a contact fraction of that wheel; estimate, for each wheel of the plurality of wheels, based on the contact fraction of that wheel, a contact area of a tire mounted on that wheel; and perform at least one of the following: (i) control a display to display the amount of contact area of at least one tire of the plurality of tires, (ii) control a central tire inflation system of the vehicle to inflate or deflate the at least one tire of the plurality of tires based on the contact area of the at least one tire, or any combination thereof.

In some non-limiting embodiments or aspects, the system further includes: a plurality of central tire inflation valves associated with the plurality of wheels; the central tire inflation system fluidically coupled to the plurality of wheels via a plurality of fluid lines and the plurality of central tire inflation valves.

In some non-limiting embodiments or aspects, the plurality of sensors includes a plurality of strain gauges.

In some non-limiting embodiments or aspects, the strain measurements are obtained by performing at least one of the following: measuring a strain on a wheel using a strain gauge provided directly on the wheel; measuring the strain on the wheel through an intermediary component attached to the wheel with the strain gauge mounted to the intermediary component; measuring the strain on the wheel using a bonded piezoelectric material; measuring a compressive load between a rim of the wheel and a tire bead of a tire mounted on the wheel, or any combination thereof.

In some non-limiting embodiments or aspects, the controller is operatively connected to each sensor of the plurality of sensors in one of a wireless configuration or a wired configuration.

In some non-limiting embodiments or aspects, a wheel of the plurality of wheels includes a circular rim having formed coaxially on opposite ends thereof outwardly flaring circumferential flange sections disposed to be engaged by beads of the tire mounted on the rim, wherein the rim further includes intermediate the opposite ends thereof a transverse wall section extending transversely of an axis of the rim, and having therethrough a central opening disposed coaxially of the axis, and wherein the central tire inflation valve is secured to a side of the transverse wall section and includes a pair of air inlet/outlet ducts.

In some non-limiting embodiments or aspects, a wheel of the plurality of wheels includes a two-piece wheel, and wherein the two-piece wheel includes an inner rim half and an outer rim half held together with fastening members.

In some non-limiting embodiments or aspects, the controller including at least one processor is further configured to: estimate, based on the contact fraction of each wheel of the plurality of wheels and a current tire pressure of each wheel of the plurality of wheels, a relative load on each wheel of the plurality of wheels; and perform at least one of the following: (i) control a display to display the relative load on each wheel of the plurality of wheels, (ii) control the central tire inflation system of the vehicle to inflate or deflate the at least one tire of the plurality of tires based on the relative load on each wheel of the plurality of wheels, or any combination thereof.

According to some non-limiting embodiments or aspects, provided is a method for monitoring wheel performance of a vehicle, the vehicle including a plurality of wheels, a plurality of tires mounted on the plurality of wheels, and a plurality of sensors on the plurality of wheels, the method including: receiving, with at least one processor, for each wheel of the plurality of wheels, from a sensor of the plurality of sensors on that wheel, a strain measurement associated with that wheel; calculating, with the at least one processor, for each wheel of the plurality of wheels, based on the strain measurement associated with that wheel, a rate of strain change of that wheel; determining, with the at least one processor, for each wheel of the plurality of wheels, based on the rate of strain change, a maximum rate of strain change of that wheel and a minimum rate of strain change of that wheel; calculating, with the at least one processor, for each wheel of the plurality of wheels, based on the maximum rate of strain change and the minimum rate of strain change, a contact fraction of that wheel; estimating, with the at least one processor, for each wheel of the plurality of wheels, based on the contact fraction of that wheel, a contact area of a tire mounted on that wheel; and performing, with the at least one processor, at least one of the following: (i) controlling a display to display the amount of contact area of at least one tire of the plurality of tires, (ii) controlling a central tire inflation system of the vehicle to inflate or deflate the at least one tire of the plurality of tires based on the contact area of the at least one tire, or any combination thereof.

In some non-limiting embodiments or aspects, the central tire inflation system is fluidically coupled to the plurality of wheels via a plurality of fluid lines and a plurality of central tire inflation valves associated with the plurality of wheels.

In some non-limiting embodiments or aspects the plurality of sensors includes a plurality of strain gauges.

In some non-limiting embodiments or aspects, the strain measurements are obtained by performing at least one of the following: measuring a strain on a wheel using a strain gauge provided directly on the wheel; measuring the strain on the wheel through an intermediary component attached to the wheel with the strain gauge mounted to the intermediary component; measuring the strain on the wheel using a bonded piezoelectric material; measuring a compressive load between a rim of the wheel and a tire bead of a tire mounted on the wheel, or any combination thereof.

In some non-limiting embodiments or aspects, a controller including the at least one processor is operatively connected to each sensor of the plurality of sensors in one of a wireless configuration or a wired configuration.

In some non-limiting embodiments or aspects, a wheel of the plurality of wheels includes a circular rim having formed coaxially on opposite ends thereof outwardly flaring circumferential flange sections disposed to be engaged by beads of the tire mounted on the rim, wherein the rim further includes intermediate the opposite ends thereof a transverse wall section extending transversely of an axis of the rim, and having therethrough a central opening disposed coaxially of the axis, and wherein the central tire inflation valve is secured to a side of the transverse wall section and includes a pair of air inlet/outlet ducts.

In some non-limiting embodiments or aspects, a wheel of the plurality of wheels includes a two-piece wheel, and wherein the two-piece wheel includes an inner rim half and an outer rim half held together with fastening members.

In some non-limiting embodiments or aspects, the method further includes: estimating, with the at least one processor, based on the contact fraction of each wheel of the plurality of wheels and a current tire pressure of each wheel of the plurality of wheels, a relative load on each wheel of the plurality of wheels; and performing, with the at least one processor, at least one of the following: (i) controlling a display to display the relative load on each wheel of the plurality of wheels, (ii) controlling the central tire inflation system of the vehicle to inflate or deflate the at least one tire of the plurality of tires based on the relative load on each wheel of the plurality of wheels, or any combination thereof.

According to some non-limiting embodiments or aspects, provided is a computer program product including at least one non-transitory computer-readable medium including program instructions for monitoring wheel performance of a vehicle, the vehicle including a plurality of wheels, a plurality of tires mounted on the plurality of wheels, and a plurality of sensors on the plurality of wheels, that, when executed by at least one processor, cause the at least one processor to: receive, for each wheel of the plurality of wheels, from a sensor of the plurality of sensors on that wheel, a strain measurement associated with that wheel; calculate, for each wheel of the plurality of wheels, based on the strain measurement associated with that wheel, a rate of strain change of that wheel; determine, for each wheel of the plurality of wheels, based on the rate of strain change, a maximum rate of strain change of that wheel and a minimum rate of strain change of that wheel; calculate, for each wheel of the plurality of wheels, based on the maximum rate of strain change and the minimum rate of strain change, a contact fraction of that wheel; estimate, for each wheel of the plurality of wheels, based on the contact fraction of that wheel, a contact area of a tire mounted on that wheel; and perform at least one of the following: (i) control a display to display the amount of contact area of at least one tire of the plurality of tires, (ii) control a central tire inflation system of the vehicle to inflate or deflate the at least one tire of the plurality of tires based on the contact area of the at least one tire, or any combination thereof.

In some non-limiting embodiments or aspects, the central tire inflation system is fluidically coupled to the plurality of wheels via a plurality of fluid lines and a plurality of central tire inflation valves associated with the plurality of wheels.

In some non-limiting embodiments or aspects, the plurality of sensors includes a plurality of strain gauges.

In some non-limiting embodiments or aspects, the strain measurements are obtained by performing at least one of the following: measuring a strain on a wheel using a strain gauge provided directly on the wheel; measuring the strain on the wheel through an intermediary component attached to the wheel with the strain gauge mounted to the intermediary component; measuring the strain on the wheel using a bonded piezoelectric material; measuring a compressive load between a rim of the wheel and a tire bead of a tire mounted on the wheel, or any combination thereof.

In some non-limiting embodiments or aspects, a controller including the at least one processor is operatively connected to each sensor of the plurality of sensors in one of a wireless configuration or a wired configuration.

In some non-limiting embodiments or aspects, a wheel of the plurality of wheels includes a circular rim having formed coaxially on opposite ends thereof outwardly flaring circumferential flange sections disposed to be engaged by beads of the tire mounted on the rim, wherein the rim further includes intermediate the opposite ends thereof a transverse wall section extending transversely of an axis of the rim, and having therethrough a central opening disposed coaxially of the axis, and wherein the central tire inflation valve is secured to a side of the transverse wall section and includes a pair of air inlet/outlet ducts.

In some non-limiting embodiments or aspects, a wheel of the plurality of wheels includes a two-piece wheel, and wherein the two-piece wheel includes an inner rim half and an outer rim half held together with fastening members.

In some non-limiting embodiments or aspects, the program instructions, when executed by the at least one processor, further causer the at least one processor to: estimate, based on the contact fraction of each wheel of the plurality of wheels and a current tire pressure of each wheel of the plurality of wheels, a relative load on each wheel of the plurality of wheels; and perform at least one of the following: (i) controlling a display to display the relative load on each wheel of the plurality of wheels, (ii) controlling the central tire inflation system of the vehicle to inflate or deflate the at least one tire of the plurality of tires based on the relative load on each wheel of the plurality of wheels, or any combination thereof.

Further embodiments are set forth in the following numbered clauses:

Clause 1: A system for monitoring wheel performance of a vehicle, the vehicle including a plurality of wheels and a plurality of tires mounted on the plurality of wheels, the system comprising: a plurality of sensors on the plurality of wheels; a controller operatively connected to the plurality of sensors, the controller including at least one processor configured to: receive measurements from the plurality of sensors on the plurality of wheels; determine, for each wheel of the plurality of wheels, based on the measurements from a sensor of the plurality of sensors on that wheel, an angular acceleration of that wheel; calculate, for each wheel of the plurality of wheels, based on the angular acceleration of that wheel, an angular jerk of that wheel; determine, for each wheel of the plurality of wheels, based on the angular jerk of that wheel, an amount of tire slip for that wheel; and perform at least one of the following: (i) control a display to display the amount of tire slip of at least one wheel of the plurality of wheels, (ii) control a central tire inflation system of the vehicle to inflate or deflate at least one tire of the plurality of tires mounted on the at least one wheel based on the amount of tire slip of the at least one wheel, or any combination thereof.

Clause 2: The system of clause 1, wherein the controller including the at least one processor is further configured to: receive, from the vehicle, a current vehicle velocity; determine, for each wheel of the plurality of wheels, based on the current vehicle velocity, an angular velocity of that wheel, and a known effective wheel radius of that wheel, a wheel slip ratio of that wheel; and perform at least one of the following: (i) control the display to display the wheel slip ratio of the at least one wheel of the plurality of wheels, (ii) control the central tire inflation system of the vehicle to inflate or deflate the at least one tire of the plurality of tires mounted on the at least one wheel based on the wheel slip ratio of the at least one wheel, or any combination thereof.

Clause 3: The system of clause 1 or 2, wherein the sensor includes at least one of an accelerometer, a gyrometer, or any combination thereof, and wherein the measurements comprise at least one of acceleration measurements obtained from the accelerometer, angular velocity measurements obtained from the gyrometer, or any combination thereof.

Clause 4: The system of any of clauses 1-3, further comprising: a plurality of central tire inflation valves associated with the plurality of wheels; and the central tire inflation system fluidically coupled to the plurality of wheels via a plurality of fluid lines and the plurality of central tire inflation valves.

Clause 5: The system of any of clauses 1-4, wherein the controller is operatively connected to each sensor of the plurality of sensors in one of a wireless configuration or a wired configuration.

Clause 6: The system of any of clauses 1-5, wherein a wheel of the plurality of wheels includes a circular rim having formed coaxially on opposite ends thereof outwardly flaring circumferential flange sections disposed to be engaged by beads of a tire mounted on the rim of the wheel, wherein the rim further includes intermediate the opposite ends thereof a transverse wall section extending transversely of an axis of the rim and having therethrough a central opening disposed coaxially of the axis of the rim, wherein a central tire inflation valve of the plurality of central tire inflation valves is secured to a side of the transverse wall section, and wherein the central tire inflation valve includes a pair of air inlet/outlet ducts.

Clause 7: The system of any of clauses 1-6, wherein a wheel of the plurality of wheels includes a two-piece wheel, and wherein the two-piece wheel includes an inner rim half and an outer rim half held together with fastening members.

Clause 8: A method for monitoring wheel performance of a vehicle, the vehicle including a plurality of wheels, a plurality of tires mounted on the plurality of wheels, and a plurality of sensors on the plurality of wheels, the method comprising: receiving, with at least one processor, measurements from the plurality of sensors on the plurality of wheels; determining, with the at least one processor, for each wheel of the plurality of wheels, based on the measurements from a sensor of the plurality of sensors on that wheel, an angular acceleration of that wheel; calculating, with the at least one processor, for each wheel of the plurality of wheels, based on the angular acceleration of that wheel, an angular jerk of that wheel; determining, with the at least one processor, for each wheel of the plurality of wheels, based on the angular jerk of that wheel, an amount of tire slip for that wheel; and performing, with the at least one processor, at least one of the following: (i) controlling a display to display the amount of tire slip of at least one wheel of the plurality of wheels, (ii) controlling a central tire inflation system of the vehicle to inflate or deflate at least one tire of the plurality of tires mounted on the at least one wheel based on the amount of tire slip of the at least one wheel, or any combination thereof.

Clause 9: The method of clause 8, further comprising: receiving, with the at least one processor, from the vehicle, a current vehicle velocity; determining, with the at least one processor, for each wheel of the plurality of wheels, based on the current vehicle velocity, an angular velocity of that wheel, and a known effective wheel radius of that wheel, a wheel slip ratio of that wheel; and performing, with the at least one processor, at least one of the following: (i) controlling the display to display the wheel slip ratio of the at least one wheel of the plurality of wheels, (ii) controlling the central tire inflation system of the vehicle to inflate or deflate the at least one tire of the plurality of tires mounted on the at least one wheel based on the wheel slip ratio of the at least one wheel, or any combination thereof.

Clause 10: The method of clause 8 or 9, wherein the sensor includes at least one of an accelerometer, a gyrometer, or any combination thereof, and wherein the measurements comprise at least one of acceleration measurements obtained from the accelerometer, angular velocity measurements obtained from the gyrometer, or any combination thereof.

Clause 11: The method of any of clauses 8-10, wherein the central tire inflation system is fluidically coupled to the plurality of wheels via a plurality of fluid lines and a plurality of central tire inflation valves associated with the plurality of wheels.

Clause 12: The method of any of clauses 8-11, wherein a controller including the at least one processor is operatively connected to each sensor of the plurality of sensors in one of a wireless configuration or a wired configuration.

Clause 13: The method of any of clauses 8-12, wherein a wheel of the plurality of wheels includes a circular rim having formed coaxially on opposite ends thereof outwardly flaring circumferential flange sections disposed to be engaged by beads of a tire mounted on the rim of the wheel, wherein the rim further includes intermediate the opposite ends thereof a transverse wall section extending transversely of an axis of the rim and having therethrough a central opening disposed coaxially of the axis of the rim, wherein a central tire inflation valve of the plurality of central tire inflation valves is secured to a side of the transverse wall section, and wherein the central tire inflation valve includes a pair of air inlet/outlet ducts.

Clause 14: The method of any of clauses 8-13, wherein a wheel of the plurality of wheels includes a two-piece wheel, and wherein the two-piece wheel includes an inner rim half and an outer rim half held together with fastening members.

Clause 15: A computer program product comprising at least one non-transitory computer-readable medium including program instructions for monitoring wheel performance of a vehicle, the vehicle including a plurality of wheels, a plurality of tires mounted on the plurality of wheels, and a plurality of sensors on the plurality of wheels, that, when executed by at least one processor, cause the at least one processor to: receive measurements from the plurality of sensors on the plurality of wheels; determine for each wheel of the plurality of wheels, based on the measurements from a sensor of the plurality of sensors on that wheel, an angular acceleration of that wheel; calculate, for each wheel of the plurality of wheels, based on the angular acceleration of that wheel, an angular jerk of that wheel; determine, for each wheel of the plurality of wheels, based on the angular jerk of that wheel, an amount of tire slip for that wheel; and perform at least one of the following: (i) controlling a display to display the amount of tire slip of at least one wheel of the plurality of wheels, (ii) controlling a central tire inflation system of the vehicle to inflate or deflate at least one tire of the plurality of tires mounted on the at least one wheel based on the amount of tire slip of the at least one wheel, or any combination thereof.

Clause 16: The computer program product of clause 15, wherein the program instructions, when executed by the at least one processor, further cause the at least one processor to: receive, from the vehicle, a current vehicle velocity; determine, for each wheel of the plurality of wheels, based on the current vehicle velocity, an angular velocity of that wheel, and a known effective wheel radius of that wheel, a wheel slip ratio of that wheel; and perform at least one of the following: (i) controlling the display to display the wheel slip ratio of the at least one wheel of the plurality of wheels, (ii) controlling the central tire inflation system of the vehicle to inflate or deflate the at least one tire of the plurality of tires mounted on the at least one wheel based on the wheel slip ratio of the at least one wheel, or any combination thereof.

Clause 17: The computer program product of clause 15 or 16, wherein the sensor includes at least one of an accelerometer, a gyrometer, or any combination thereof, and wherein the measurements comprise at least one of acceleration measurements obtained from the accelerometer, angular velocity measurements obtained from the gyrometer, or any combination thereof, and wherein the central tire inflation system is fluidically coupled to the plurality of wheels via a plurality of fluid lines and a plurality of central tire inflation valves associated with the plurality of wheels.

Clause 18: The computer program product of any of clauses 15-17, wherein a controller including the at least one processor is operatively connected to each sensor of the plurality of sensors in one of a wireless configuration or a wired configuration.

Clause 19: The computer program product of any of clauses 15-18, wherein a wheel of the plurality of wheels includes a circular rim having formed coaxially on opposite ends thereof outwardly flaring circumferential flange sections disposed to be engaged by beads of a tire mounted on the rim of the wheel, wherein the rim further includes intermediate the opposite ends thereof a transverse wall section extending transversely of an axis of the rim and having therethrough a central opening disposed coaxially of the axis of the rim, wherein a central tire inflation valve of the plurality of central tire inflation valves is secured to a side of the transverse wall section, and wherein the central tire inflation valve includes a pair of air inlet/outlet ducts.

Clause 20: The computer program product of any of clauses 15-19, wherein a wheel of the plurality of wheels includes a two-piece wheel, and wherein the two-piece wheel includes an inner rim half and an outer rim half held together with fastening members.

Clause 21: A system for monitoring wheel performance of a vehicle, the vehicle including a plurality of wheels and a plurality of tires mounted on the plurality of wheels, the system comprising: a plurality of sensors on the plurality of wheels; a controller operatively connected to the plurality of sensors, the controller including at least one processor configured to: receive, for each wheel of the plurality of wheels, from a sensor of the plurality of sensors on that wheel, a strain measurement associated with that wheel; calculate, for each wheel of the plurality of wheels, based on the strain measurement associated with that wheel, a rate of strain change of that wheel; determine, for each wheel of the plurality of wheels, based on the rate of strain change, a maximum rate of strain change of that wheel and a minimum rate of strain change of that wheel; calculate, for each wheel of the plurality of wheels, based on the maximum rate of strain change and the minimum rate of strain change, a contact fraction of that wheel; estimate, for each wheel of the plurality of wheels, based on the contact fraction of that wheel, a contact area of a tire mounted on that wheel; and perform at least one of the following: (i) control a display to display the amount of contact area of at least one tire of the plurality of tires, (ii) control a central tire inflation system of the vehicle to inflate or deflate the at least one tire of the plurality of tires based on the contact area of the at least one tire, or any combination thereof.

Clause 22: The system of clause 21, further comprising: a plurality of central tire inflation valves associated with the plurality of wheels; the central tire inflation system fluidically coupled to the plurality of wheels via a plurality of fluid lines and the plurality of central tire inflation valves.

Clause 23: The system of clause 21 or 22, wherein the plurality of sensors includes a plurality of strain gauges.

Clause 24: The system of any of clauses 21-23, wherein the strain measurements are obtained by performing at least one of the following: measuring a strain on a wheel using a strain gauge provided directly on the wheel; measuring the strain on the wheel through an intermediary component attached to the wheel with the strain gauge mounted to the intermediary component; measuring the strain on the wheel using a bonded piezoelectric material; measuring a compressive load between a rim of the wheel and a tire bead of a tire mounted on the wheel, or any combination thereof.

Clause 25: The system of any of clauses 21-24, wherein the controller is operatively connected to each sensor of the plurality of sensors in one of a wireless configuration or a wired configuration.

Clause 26: The system of any of clauses 21-25, wherein a wheel of the plurality of wheels includes a circular rim having formed coaxially on opposite ends thereof outwardly flaring circumferential flange sections disposed to be engaged by beads of the tire mounted on the rim, wherein the rim further includes intermediate the opposite ends thereof a transverse wall section extending transversely of an axis of the rim, and having therethrough a central opening disposed coaxially of the axis, and wherein the central tire inflation valve is secured to a side of the transverse wall section and includes a pair of air inlet/outlet ducts.

Clause 27: The system of any of clauses 21-26, wherein a wheel of the plurality of wheels includes a two-piece wheel, and wherein the two-piece wheel includes an inner rim half and an outer rim half held together with fastening members.

Clause 28: The system of any of clauses 21-27, wherein the controller including at least one processor is further configured to: estimate, based on the contact fraction of each wheel of the plurality of wheels and a current tire pressure of each wheel of the plurality of wheels, a relative load on each wheel of the plurality of wheels; and perform at least one of the following: (i) control a display to display the relative load on each wheel of the plurality of wheels, (ii) control the central tire inflation system of the vehicle to inflate or deflate the at least one tire of the plurality of tires based on the relative load on each wheel of the plurality of wheels, or any combination thereof.

Clause 29: A method for monitoring wheel performance of a vehicle, the vehicle including a plurality of wheels, a plurality of tires mounted on the plurality of wheels, and a plurality of sensors on the plurality of wheels, the method comprising: receiving, with at least one processor, for each wheel of the plurality of wheels, from a sensor of the plurality of sensors on that wheel, a strain measurement associated with that wheel; calculating, with the at least one processor, for each wheel of the plurality of wheels, based on the strain measurement associated with that wheel, a rate of strain change of that wheel; determining, with the at least one processor, for each wheel of the plurality of wheels, based on the rate of strain change, a maximum rate of strain change of that wheel and a minimum rate of strain change of that wheel; calculating, with the at least one processor, for each wheel of the plurality of wheels, based on the maximum rate of strain change and the minimum rate of strain change, a contact fraction of that wheel; estimating, with the at least one processor, for each wheel of the plurality of wheels, based on the contact fraction of that wheel, a contact area of a tire mounted on that wheel; and performing, with the at least one processor, at least one of the following: (i) controlling a display to display the amount of contact area of at least one tire of the plurality of tires, (ii) controlling a central tire inflation system of the vehicle to inflate or deflate the at least one tire of the plurality of tires based on the contact area of the at least one tire, or any combination thereof.

Clause 30: The method of clause 29, wherein the central tire inflation system is fluidically coupled to the plurality of wheels via a plurality of fluid lines and a plurality of central tire inflation valves associated with the plurality of wheels.

Clause 31: The method of clause 29 or 30, wherein the plurality of sensors includes a plurality of strain gauges.

Clause 32: The method of any of clauses 29-31, wherein the strain measurements are obtained by performing at least one of the following: measuring a strain on a wheel using a strain gauge provided directly on the wheel; measuring the strain on the wheel through an intermediary component attached to the wheel with the strain gauge mounted to the intermediary component; measuring the strain on the wheel using a bonded piezoelectric material; measuring a compressive load between a rim of the wheel and a tire bead of a tire mounted on the wheel, or any combination thereof.

Clause 33: The method of any of clauses 29-32, wherein a controller including the at least one processor is operatively connected to each sensor of the plurality of sensors in one of a wireless configuration or a wired configuration.

Clause 34: The method of any of clauses 29-33, wherein a wheel of the plurality of wheels includes a circular rim having formed coaxially on opposite ends thereof outwardly flaring circumferential flange sections disposed to be engaged by beads of the tire mounted on the rim, wherein the rim further includes intermediate the opposite ends thereof a transverse wall section extending transversely of an axis of the rim, and having therethrough a central opening disposed coaxially of the axis, and wherein the central tire inflation valve is secured to a side of the transverse wall section and includes a pair of air inlet/outlet ducts.

Clause 35: The method of any of clauses 29-34, wherein a wheel of the plurality of wheels includes a two-piece wheel, and wherein the two-piece wheel includes an inner rim half and an outer rim half held together with fastening members.

Clause 36: The method of any of clauses 29-35, further comprising: estimating, with the at least one processor, based on the contact fraction of each wheel of the plurality of wheels and a current tire pressure of each wheel of the plurality of wheels, a relative load on each wheel of the plurality of wheels; and performing, with the at least one processor, at least one of the following: (i) controlling a display to display the relative load on each wheel of the plurality of wheels, (ii) controlling the central tire inflation system of the vehicle to inflate or deflate the at least one tire of the plurality of tires based on the relative load on each wheel of the plurality of wheels, or any combination thereof.

Clause 37: A computer program product comprising at least one non-transitory computer-readable medium including program instructions for monitoring wheel performance of a vehicle, the vehicle including a plurality of wheels, a plurality of tires mounted on the plurality of wheels, and a plurality of sensors on the plurality of wheels, that, when executed by at least one processor, cause the at least one processor to: receive, for each wheel of the plurality of wheels, from a sensor of the plurality of sensors on that wheel, a strain measurement associated with that wheel; calculate, for each wheel of the plurality of wheels, based on the strain measurement associated with that wheel, a rate of strain change of that wheel; determine, for each wheel of the plurality of wheels, based on the rate of strain change, a maximum rate of strain change of that wheel and a minimum rate of strain change of that wheel; calculate, for each wheel of the plurality of wheels, based on the maximum rate of strain change and the minimum rate of strain change, a contact fraction of that wheel; estimate, for each wheel of the plurality of wheels, based on the contact fraction of that wheel, a contact area of a tire mounted on that wheel; and perform at least one of the following: (i) control a display to display the amount of contact area of at least one tire of the plurality of tires, (ii) control a central tire inflation system of the vehicle to inflate or deflate the at least one tire of the plurality of tires based on the contact area of the at least one tire, or any combination thereof.

Clause 38: The computer program product of clause 37, wherein the central tire inflation system is fluidically coupled to the plurality of wheels via a plurality of fluid lines and a plurality of central tire inflation valves associated with the plurality of wheels.

Clause 39: The computer program product of clause 37 or 38, wherein the plurality of sensors includes a plurality of strain gauges.

Clause 40: The computer program product of any of clauses 37-39, wherein the strain measurements are obtained by performing at least one of the following: measuring a strain on a wheel using a strain gauge provided directly on the wheel; measuring the strain on the wheel through an intermediary component attached to the wheel with the strain gauge mounted to the intermediary component; measuring the strain on the wheel using a bonded piezoelectric material; measuring a compressive load between a rim of the wheel and a tire bead of a tire mounted on the wheel, or any combination thereof.

Clause 41: The computer program product of any of clauses 37-40, wherein a controller including the at least one processor is operatively connected to each sensor of the plurality of sensors in one of a wireless configuration or a wired configuration.

Clause 42: The computer program product of any of clauses 37-41, wherein a wheel of the plurality of wheels includes a circular rim having formed coaxially on opposite ends thereof outwardly flaring circumferential flange sections disposed to be engaged by beads of the tire mounted on the rim, wherein the rim further includes intermediate the opposite ends thereof a transverse wall section extending transversely of an axis of the rim, and having therethrough a central opening disposed coaxially of the axis, and wherein the central tire inflation valve is secured to a side of the transverse wall section and includes a pair of air inlet/outlet ducts.

Clause 43: The computer program product of any of clauses 37-42, wherein a wheel of the plurality of wheels includes a two-piece wheel, and wherein the two-piece wheel includes an inner rim half and an outer rim half held together with fastening members.

Clause 44: The computer program product of any of clauses 37-44, wherein the program instructions, when executed by the at least one processor, further causer the at least one processor to: estimate, based on the contact fraction of each wheel of the plurality of wheels and a current tire pressure of each wheel of the plurality of wheels, a relative load on each wheel of the plurality of wheels; and perform at least one of the following: (i) controlling a display to display the relative load on each wheel of the plurality of wheels, (ii) controlling the central tire inflation system of the vehicle to inflate or deflate the at least one tire of the plurality of tires based on the relative load on each wheel of the plurality of wheels, or any combination thereof.

These and other features and characteristics of the presently disclosed subject matter, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter. As used in the specification and the claims, the singular forms of “a,” “an,” and “the” include plural referents unless the context clearly dictates otherwise.

### BRIEF DESCRIPTION OF THE DRAWINGS

Additional advantages and details of the disclosed subject matter are explained in greater detail below with reference to the exemplary embodiments that are illustrated in the accompanying figures, in which:

FIG. 1A is a perspective view of a sensor assembly configured to be mounted on a wheel of a vehicle, according to non-limiting embodiments or aspects of the present disclosure;

FIG. 1B is a perspective view of a wheel having the sensor assembly of FIG. 1A mounted thereon, according to non-limiting embodiments or aspects of the present disclosure;

FIG. 2 is a perspective view of a wheel of a vehicle having a central tire inflation valve, according to non-limiting embodiments or aspects of the present disclosure;

FIG. 3 is a perspective view of a wheel of a vehicle having the sensor assembly of FIG. 1A mounted thereto in a first non-limiting configuration, according to non-limiting embodiments or aspects of the present disclosure;

FIG. 4 is a perspective view of a wheel of a vehicle having the sensor assembly of FIG. 1A mounted thereto in a second non-limiting configuration, according to non-limiting embodiments or aspects of the present disclosure;

FIG. 5 is a schematic diagram of a wireless central tire inflation system for a vehicle, according to non-limiting embodiments or aspects of the present disclosure

FIG. 6 is a schematic diagram of a wired central tire inflation system for a vehicle, according to non-limiting embodiments or aspects of the present disclosure;

FIG. 7 is a block diagram of a central tire inflation system for a vehicle, according to non-limiting embodiments or aspects of the present disclosure;

FIG. 8 is a flow chart illustrating a method of estimating tire slip, according to non-limiting embodiments or aspects of the present disclosure;

FIG. 9 is a schematic diagram illustrating tire slip, according to non-limiting embodiments or aspects of the present disclosure;

FIG. 10 is a flow chart illustrating a method of estimating contact patch area, according to non-limiting embodiments or aspects of the present disclosure;

FIG. 11 is a schematic diagram illustrating contact patch area, according to non-limiting embodiments or aspects of the present disclosure;

FIG. 12 provides a series of graphs illustrating a manner in which contact fraction may be determined, according to non-limiting embodiments or aspects of the present disclosure;

FIG. 13 is a block diagram illustrating a system for adjusting and maintaining tire pressure from inputs of pressure and temperature, according to non-limiting embodiments or aspects of the present disclosure;

FIG. 14A is a flow chart illustrating a method of estimating a relative load on each wheel, according to non-limiting embodiments or aspects of the present disclosure;

FIG. 14B illustrates a measurement of individual wheel loads from a proportional relationship between contact fraction and tire pressure, according to non-limiting embodiments or aspects of the present disclosure;

FIG. 15 provides a series of graphs illustrating a manner in which wheel slip ratio may be determined, according to non-limiting embodiments or aspects of the present disclosure; and

FIG. 16 is a table of example operating modes and parameters for central tire inflation (CTI) system equipped vehicles that illustrates variable tire pressures for accommodating different environments to balance tractive effort with fuel economy, according to non-limiting embodiments or aspects of the present disclosure.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosed subject matter as it is oriented in the drawing figures. However, it is to be understood that the disclosed subject matter may assume various alternative variations and step sequences, except where expressly specified to the contrary. It is also to be understood that the specific devices and processes illustrated in the attached drawings, and described in the following specification, are simply exemplary embodiments of the disclosed subject matter. Hence, specific dimensions and other physical characteristics related to the embodiments disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

Some non-limiting embodiments are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

Non-limiting embodiments or aspects of the present disclosure provide a system and method for monitoring wheel performance and/or providing feedback to a user. While the following disclosure is directed to the use of such a wheel monitoring system with a central tire inflation (CTI) system, this is not to be construed as limiting as a variety of other uses for non-limiting embodiments or aspects of the present disclosure have been envisioned. For example, a wheel performance monitoring system according to non-limiting embodiments or aspects of the present disclosure may be utilized in military vehicles requiring a leader-follower maneuvering in convoys, autonomous vehicles requiring traction control, agricultural vehicles, aircrafts, automotive racing applications, and a variety of other applications where wheel performance monitoring is beneficial. Non-limiting embodiments or aspects of wheel monitoring may be expanded to supportive services that may measure vehicle component health, for example: wheel shock, wheel vibration, wheel imbalance, wheel service life, wheel fatigue tracking, terrain measurement, tire tread wear, wheel bearings, brake wear, steering links, shock absorbers, suspension springs, and/or the like.

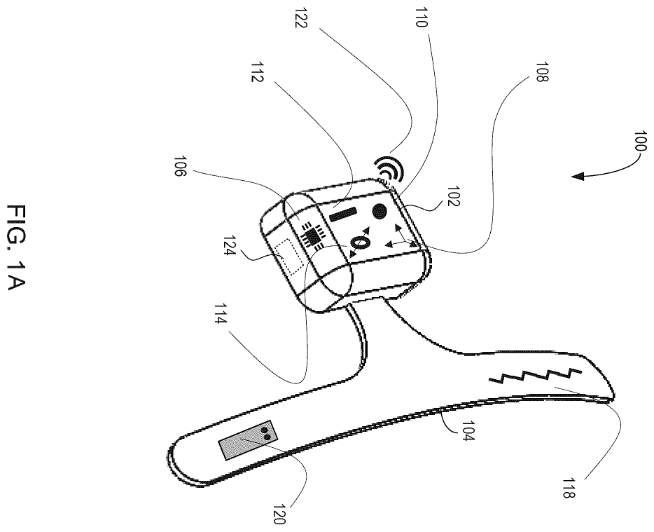

Referring now to FIG. 1A, FIG. 1A is a diagram of an exemplary sensor assembly 100, according to non-limiting embodiments or aspects. The sensor assembly 100 may include a housing 102 having a contact portion 104 extending therefrom. The contact portion 104 is configured for contacting a surface of a wheel and has one or more sensors positioned thereon. The housing 102 may have a processor 106 and various sensors positioned therein. The processor 106 may be any suitable processor (e.g., a central processing unit (CPU), a graphics processing unit (GPU), an accelerated processing unit (APU), etc.), a microprocessor, a digital signal processor (DSP), any processing component (e.g., a field-programmable gate array (FPGA), an application-specific integrated circuit (ASIC), and/or a device configured to implement logic functions etc.) that can be programmed to perform a function.

For example, the housing 102 may include at least one of the following sensors: a three-axis accelerometer 108, a pressure sensor 110, a temperature sensor 112, a gyrometer 114, or any combination thereof. Each of these sensors may be operatively coupled to the processor 106 for transmitting measured data to the processor 106. The contact portion 104 may include one or more sensors positioned thereon or integrated therewith for measuring various characteristics of the wheel. For example, the contact portion 104 may include at least one of a strain detector 118, a load detector 120, or any combination thereof. The strain detector 118 and/or the load detector 120 may be operatively coupled to the processor 106 for transmitting measured data thereto. The housing 102 may further include a transmitter 122 positioned therein. The transmitter 122 is operatively coupled to the processor 106 and is configured to transmit data from the processor to a controller of the CTI system as discussed hereinafter. The transmitter 122 may utilize any suitable wired or wireless communication protocol, examples of which include USB, TCP/IP, Ethernet, Wireless Ethernet, Bluetooth, RFID, ZigBee, M-Bus, IP, IPV6, UDP, DTN, HTTP, FTP, SNMP, CDMA, NMEA and GSM. An appropriate power supply 124, such as a battery, may be positioned within the housing 102 to provide power to the various components of the sensor assembly 100. While a battery is provided as one example of a power supply 124, this is not to be construed as limiting as various energy harvesting systems, including passive, active, and hybrid systems, may also be utilized as the power supply 124. FIG. 1B provides an illustration of the sensor assembly 100 mounted onto a wheel 200 having a tire 300.

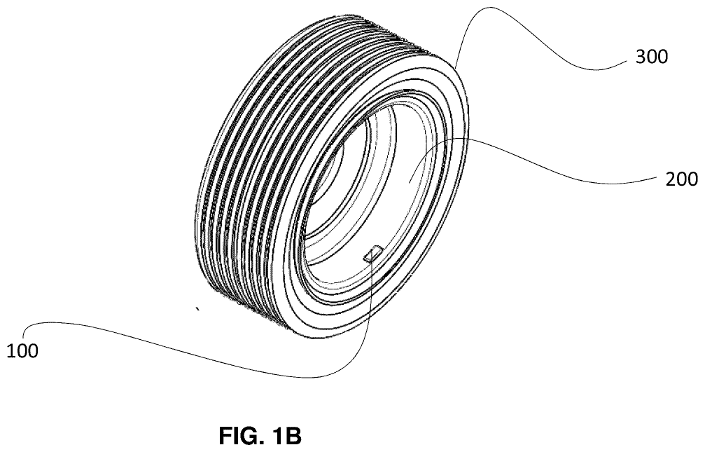

With reference to FIG. 2, a non-limiting embodiment or aspect of a wheel 200 for use with the sensor assembly 100 of FIG. 1 is illustrated. The wheel 200 may be configured as a two-piece wheel, however, this is not to be construed as limiting as a one-piece wheel or a multi-piece wheel comprising more than two pieces may be utilized. The wheel 200 may include a circular, outer rim section denoted generally by the numeral 202, and an inner, circular rim section denoted generally by the numeral 204. Intermediate its ends the outer rim section 202 has an annular wall section 206 surrounded at its open outer end by an integral, outwardly flaring circumferential flange section 208, and is closed at its inner end by an integral, transversely extending wall section 210. Section 210 has therethrough, and centrally thereof, a reduced-diameter opening 212 which is disposed coaxially of section 202, and which is surrounded coaxially by a circular array of smaller, circular openings 214 which are equiangularly spaced from each other about the axis of section 202, and in rather slight, radially spaced relation to the central opening 212.

The inner rim section 204 is generally cup-shaped in configuration, and in a same or similar manner as section 202 has intermediate its ends an annular wall section 216 having a diameter substantially equal to the annular wall section 206 of the outer rim section 202, but which has an axial length substantially greater than the axial length of the section 206. Remote from its flanged open end 218, the annular wall section 206 has integral therewith a wall section (not shown) which extends transversely of the axis of sections 202 and 204, and which has therethrough coaxially of the sections 202 and 204 a centrally disposed, circular opening. The bore wall of the opening surrounds and is coaxially engaged with the radial inner end or bottom of a recess in wall section 210 of the rim section 202.

To assemble the two sections 202 and 204 to form a wheel for accommodating a tire (not shown), the wall section of the inner rim section 204 is seated in against the wall section 210 of section 202 in such manner that a circular array of circular openings in the section 210 register with a like, array of circular openings in the wall section of the of inner rim section 204. These registering openings accommodate the externally threaded shanks of an array of bolts 220, which extend through the registering openings in the wall section 210 and the wall section of the inner rim section in order to fasten those sections securely together by nuts 222 that are screwed to the various bolts 220 in a conventional manner. A tire is mounted on the two sections 202 and 204 with the outboard and inboard beads of the tire being seated against the respective flange sections 208 and 218 prior to fastening the two sections 202 and 204 with the nuts 222 and the bolts 220.

A CTI valve 224 has therein a pair of spaced, parallel air inlet and air outlet ducts which open at their outer ends on a plane, flat bottom surface of the valve, and which communicate at their inner ends to a valve mechanism (not shown) which is housed in a recess within the valve. Additional details of the CTI valve 224 may be found in U.S. Pat. Nos. 6,474,383 and 8,087,439, which are hereby incorporated by reference in their entirety. CTI valve 224 is disposed to have its plane bottom surface secured snugly and in coplanar relation with the plane, bottom surface of a recess 226 in wall section 210 by a plurality of bolts or screws. The CTI valve 224 may be operatively connected to a valve controller 228, which is in turn operatively connected, in either a wirelessly or a wired manner, to the CTI controller discussed hereinafter.

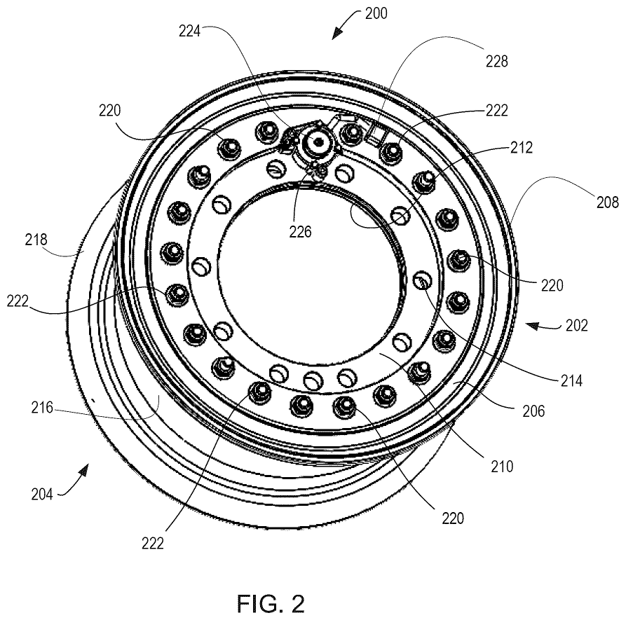

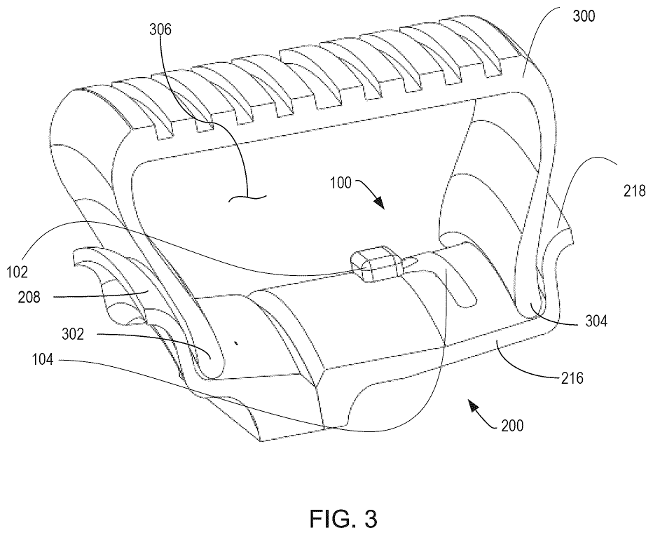

With reference to FIGS. 3 and 4, and with continued reference to FIGS. 1A and 2, non-limiting examples of the manner in which the sensor assembly 100 may be positioned on the wheel 200 are illustrated. As shown in FIG. 3, the sensor assembly 100 may be positioned on the wheel 200 in any manner suitable for measuring strain on the wheel. In such a configuration, a tire 300 is mounted on the assembled wheel 200 with the outboard and inboard beads 302 and 304, respectively, of the tire 300 being seated against the respective flange sections 208 and 218. The sensor assembly 100 may be positioned within a cavity 306 formed by the tire 300 on the wall section 216 such that the contact portion 104 of the sensor assembly 100 is provided in contact with the wall section 216. In this manner, the strain detector 118 provided on the contact portion 104 can obtain strain measurements on the wheel 200. In this configuration, the strain detector 118 may be a strain gauge, a piezoelectric sensor, or any combination thereof. Alternatively, the strain gauge may be provided indirectly (e.g., on a plate that attaches to the wheel 200, etc.). For example, strain on the wheel 200 may be measured through an intermediary component (not shown) attached to the wheel 200 with the strain detector 118 being mounted to the intermediary component rather than the wheel itself. Another manner in which to measure strain on the wheel 200 is using bonded piezoelectric material (e.g., PZT ceramic, etc.) or to measure the compressive load between the wheel 200 and the tire beads 302, 304.

With reference to FIGS. 1B and 4, in some non-limiting embodiments or aspects, s sensor assembly 100 may be positioned on the wheel 200 in a manner suitable for measuring the load on the wheel. In such a configuration, a tire 300 is mounted on the assembled wheel 200 with the outboard and inboard beads 302 and 304, respectively, of the tire 300 being seated against the respective flange sections 208 and 218. The sensor assembly 100 may be positioned within the cavity 306 formed by the tire 300 on the wall section 216 such that the contact portion 104 of the sensor assembly 100 is provided in contact with the wall section 216 and beneath the inboard bead 304 of the tire 300. In this manner, the load detector 120 provided on the contact portion 104 can obtain load measurements on the wheel 200. The load detector 120 may be configured as an Ohmite Force Sensing Resistor or a UNIAXIAL ICP® Strain Sensor.

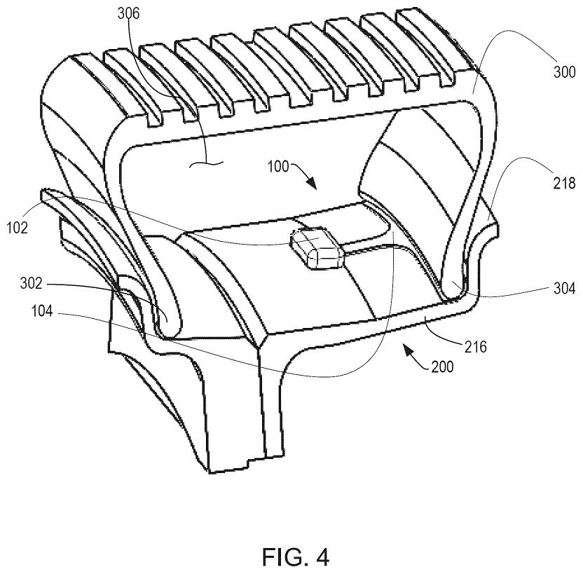

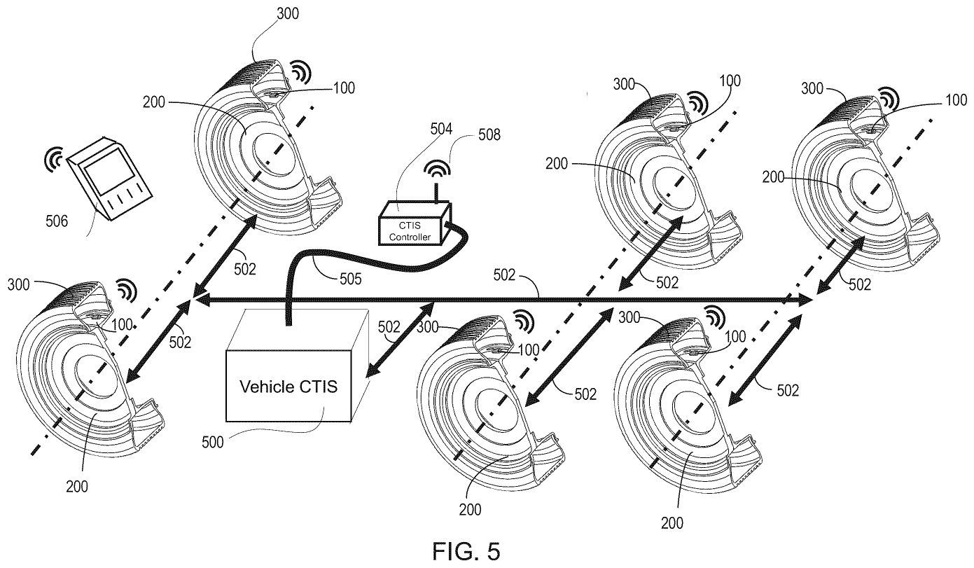

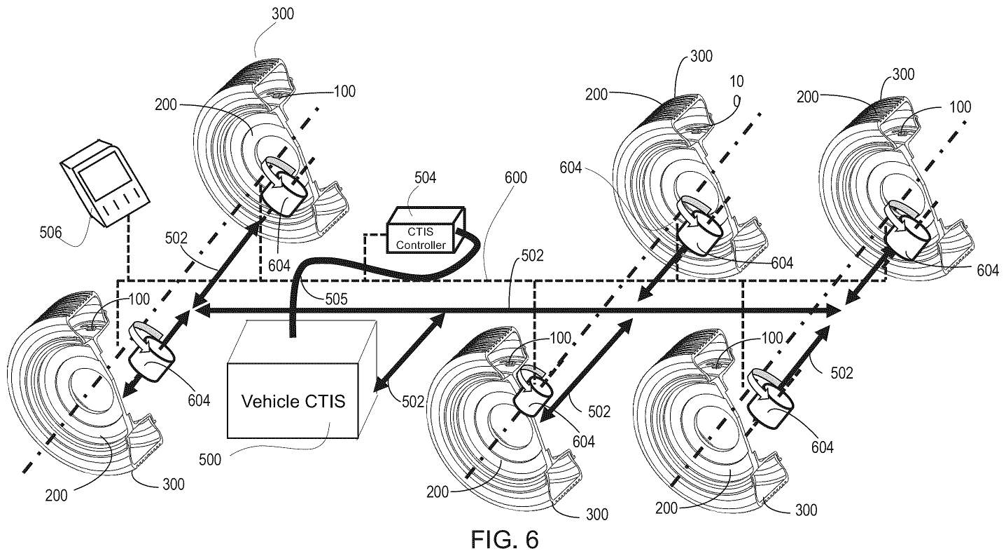

With reference to FIGS. 5 and 6, schematic diagrams of a CTI system are provided utilizing the sensor assembly 100 of FIG. 1A. FIG. 7 provides a block diagram of the CTI system shown in FIGS. 5 and 6. FIG. 5 illustrates non-limiting embodiments or aspects of a CTI system utilizing wireless communication protocols between various components, and FIG. 6 illustrates non-limiting embodiment or aspects of a CTI system utilizing wired communication protocols. These diagrams schematically illustrate a vehicle with a CTI system that includes a plurality of wheels 200, which may be provided on a chassis of the vehicle. Each of the wheels 200 is provided with a tire 300 and a sensor assembly 100. While six wheels are illustrated this is not to be construed as limiting as the CTI system may be utilized with vehicles having any number of wheels.

The CTI system may include a vehicle CTI system 500 that includes an air supply, valves, and manifolds for directing air through air lines 502 to the appropriate tire 300 of the appropriate wheel 200. A CTI controller 504 is operatively coupled to the vehicle CTI system 500 for controlling the operation of the air supply, valves, and manifolds of the vehicle CTI system so that the pressure of the tires 300 can be adequately adjusted. The CTI controller 504 may be coupled to the vehicle CTI system 500 via a controller-area network (CAN) bus 505. The CTI controller 504 may be any suitable processor (e.g., a central processing unit (CPU), a graphics processing unit (GPU), an accelerated processing unit (APU), etc.), a microprocessor, a digital signal processor (DSP), any processing component (e.g., a field-programmable gate array (FPGA), an application-specific integrated circuit (ASIC), and/or a device configured to implement logic functions etc.) that can be programmed to perform a function. The CTI controller 504 may be operatively connected to a user interface/display 506 and/or to each of the sensor assemblies 100. This connection may be a wireless connection as shown in FIG. 5 or a wired connection as shown in FIG. 6. The connection may utilize any suitable wired or wireless communication protocol, examples of which include USB, TCP/IP, Ethernet, Wireless Ethernet, Bluetooth, RFID, ZigBee, M-Bus, IP, IPV6, UDP, DTN, HTTP, FTP, SNMP, CDMA, NMEA and GSM. If a wired connection is utilized as shown in FIG. 6, system wiring 600 is utilized throughout the vehicle to provide appropriate connections between the various components. In addition, rotary couplings/slip rings 604 may be provided in the vicinity of each of the wheels to allow for a wired connection between the sensor assemblies 100, which rotate as the wheels 200 rotate, and the CTI controller 504. The user interface/display 506 may be a stand-alone user interface/display 506, may be integrated into a display already provided on the vehicle, or may be omitted entirely in an autonomous system that requires no user intervention.

The CTI controller 504 can be configured to operate in at least a manual mode and an automatic mode. When the CTI controller 504 is in the manual mode, the CTI controller 504 controls the vehicle CTI system 500 based on settings provided by the operator via the user interface/display 506. When the CTI controller 504 is in the automatic mode, the CTI controller 504 controls the vehicle CTI system 500 based at least in part on signals provided by the various sensors of the sensor assembly 100. The user interface/display 506 may be implemented as a touchscreen device or any other suitable type of display.

The addition of the sensor assembly 100 to each of the wheels 200 enables the CTI controller 504 to provide various information to the user of the system and/or control the CTI system 500 and/or CTI valves 224 to increase or decrease tire pressure. For example, the system may be configured to at least monitor tire slip utilizing an active angular acceleration measurement, determine tire contact area with active wheel strain measurements, adjust and maintain tire pressure from inputs of pressure and temperature, and/or compensate tire pressure for differing axle loads in each wheel location. While FIGS. 5 and 6 illustrate CTI controller 504 interfacing directly with the sensor assemblies 100, in an alternative implementation, the sensor assemblies 100 may interface with a separate controller or processor that is provided in communication with the CTI controller 504.

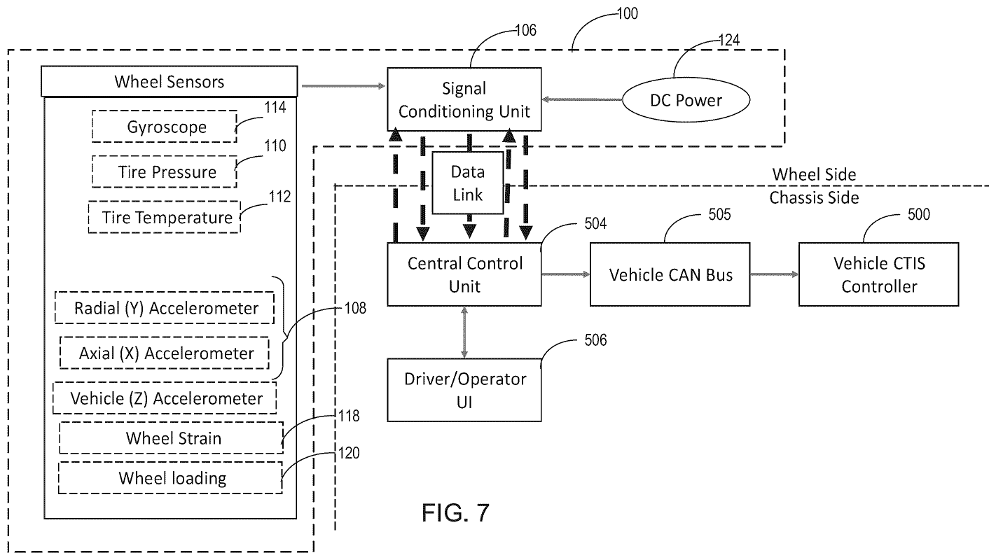

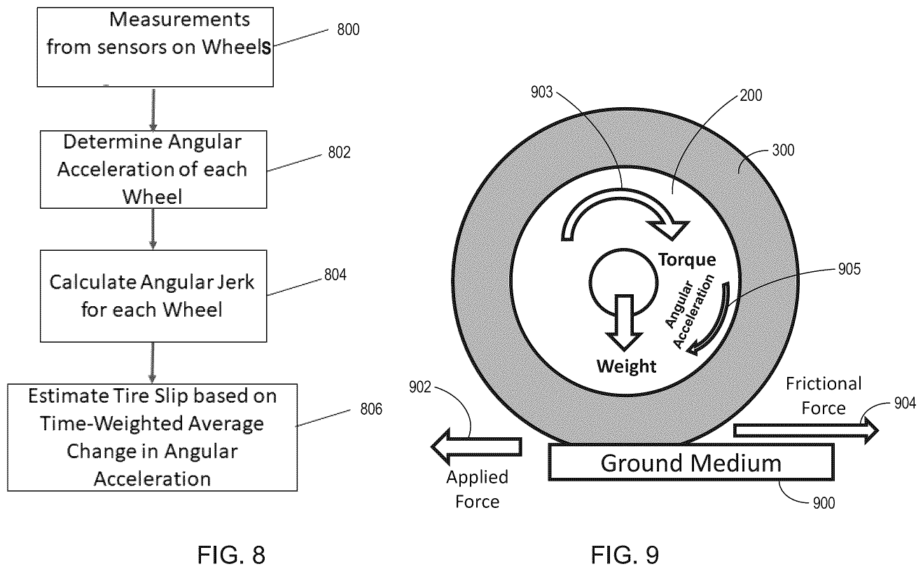

With reference to FIGS. 8 and 9, a flow diagram and a schematic diagram describing a use of a system according to non-limiting embodiments or aspects to monitor tire slip with angular acceleration measurements are provided. With reference to FIG. 8, at block 800, the CTI controller 504 receives measurements from the sensor assembly 100 positioned on each of the plurality of wheels 200. In one non-limiting embodiment or aspect, the sensor assembly 100 includes the gyrometer 114 and the measurements include gyrometer measurements. In another non-limiting embodiment or aspect, acceleration measurements from the accelerometer 108 of the sensor assembly 100 may be utilized. In still another non-limiting embodiment or aspect, a combination of gyrometer measurements and acceleration measurements may be utilized.

With continued reference to FIG. 8, the CTI controller 504, at block 802, then calculates an angular acceleration of each of the plurality of wheels 200 based on the gyrometer measurements, the acceleration measurements, or a combination of both. For example, and with reference to FIG. 9, when the wheels 200 and tires 300 of a vehicle are positioned on a ground medium 900 to support the vehicle, various forces act on each of the wheels 200 and tires 300. When the applied force 902 from the wheel torque 903 (e.g., the force provided by the vehicles drive train system to rotate the wheel, etc.) exceeds the frictional force 904 of the tire 300 in a specific ground medium 900, the wheel 200 and tire 300 may spin. The change in angular acceleration 905 can be captured by at least one of the gyrometer 114, the accelerometer 108, or any combination thereof.

Based on this information, at block 804, the CTI controller 504 may calculate the angular jerk in each of the plurality of wheels 200 based on the measured angular acceleration of each of the plurality of wheels 200. The CTI controller 504 may determine the occurrence of angular jerk in one or more wheels according to the following Equation (1).

$$Angular Jerk = \frac{Change in Wheel Angular Acceleration}{Change in Time} = \frac{{α}_{final} - {α}_{initial}}{{t}_{final} - {t}_{initial}} \qquad ( 1 )$$

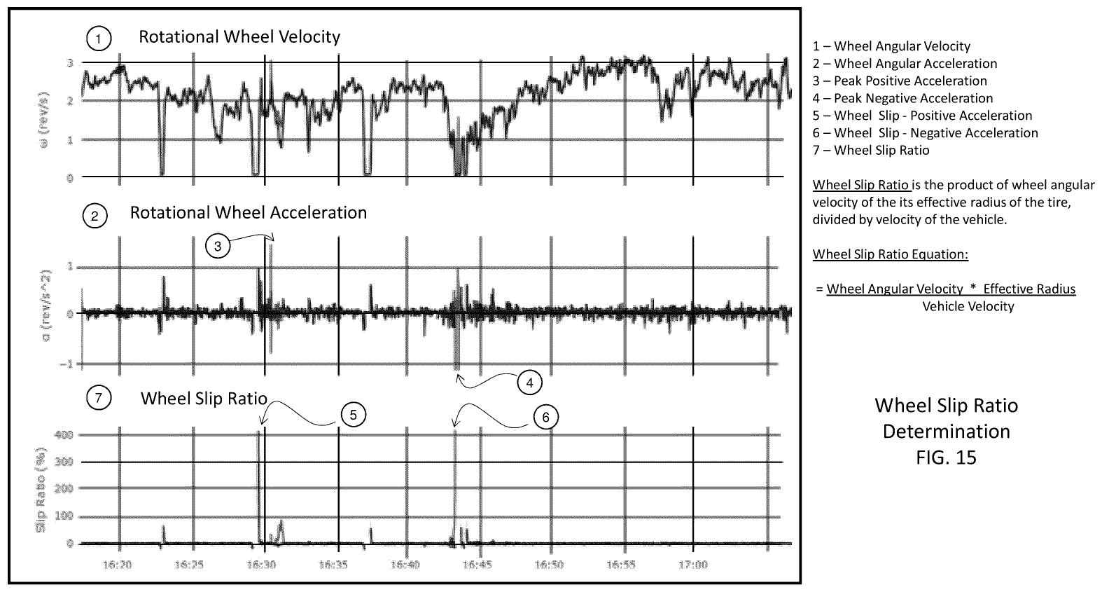

The one or more wheels with angular jerk may have active tire slip that can be confirmed by calculating wheel slip ratio as illustrated in FIG. 15 and/or according to the following Equation (2):

$$Wheel Slip Ratio = \frac{Wheel Angular Velocity * Effective Radius}{Vehicle Velocity} \qquad ( 2 )$$

Thereafter, at block 806, the CTI controller 504 may determine tire slip of each of the plurality of wheels 200 based on the angular jerk in each of the plurality of wheels. The CTI controller 504 may measure the occurrence of angular jerk in one or more wheels. The CTI controller 504 may calculate tire slip from angular jerk by integrating the jerk to determine wheel or tire acceleration and velocity and relating wheel or tire acceleration and velocity to a tire slip angle using known vehicle dynamics equations and parameters (e.g., wheel base, tire radius, etc.). These wheels may have active tire slip that can be confirmed by calculating wheel slip ratio illustrated in FIG. 15. The estimated tire slip may be displayed on the user interface/display 506. Alternatively, or additionally, the estimated tire slip may be utilized by the CTI controller 504 to control the vehicle CTI system 500 and the CTI valve 224 (e.g., via vehicle CAN bus 505, etc.) to inflate or deflate the tire 300 positioned on each of the plurality of wheels 200. For example, CTI controller 504 may use a tire pressure improvement or optimization algorithm 1300 as described herein to determine a pressure at which each of the tires 300 of each of the wheels 200 should be inflated or deflated and control the CTI system 500 to inflate or deflate each of the tires 300 of each of the wheels 200 to the determined pressure for that tire 300.

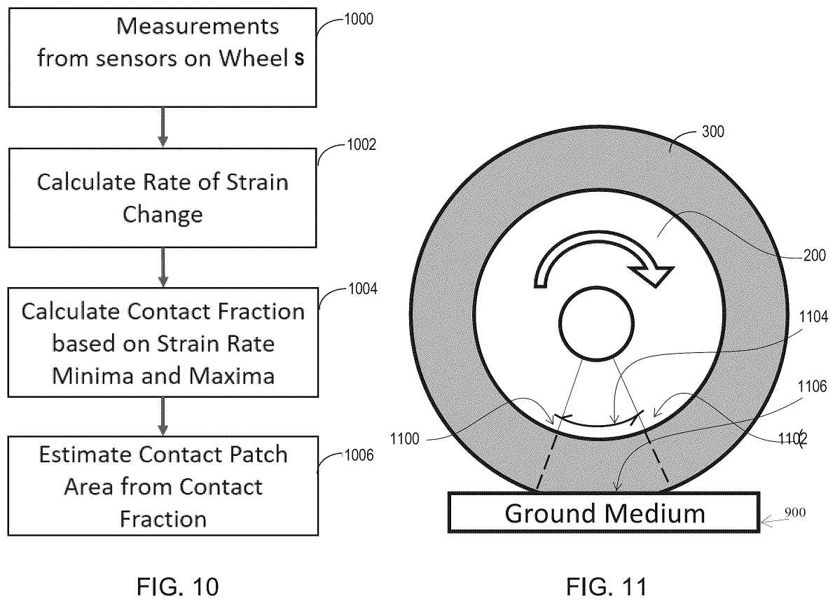

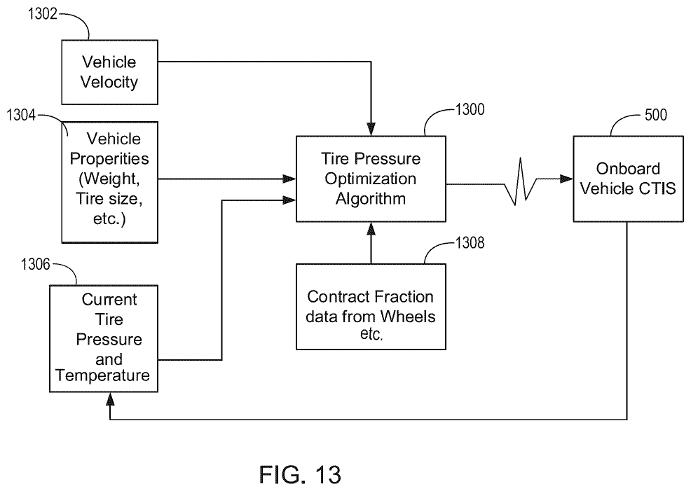

With reference to FIGS. 10-12, a flow diagram and a schematic diagram describing a use of a system according to non-limiting embodiments or aspects to determine tire contact area with active wheel strain measurements are provided. With reference to FIG. 10, at block 1000, the CTI controller 504 receives strain measurements from the strain detector 108 of the sensor assembly 100 positioned on each of the plurality of wheels 200. With reference to FIG. 12, a non-limiting exemplary graph 1 of these strain measurements is illustrated with the X-axis denoting elapsed time and the Y-axis denoting strain. This graph was obtained for a wheel 200 with a tire 300 inflated to 15 psi positioned on sand as the ground medium 900.

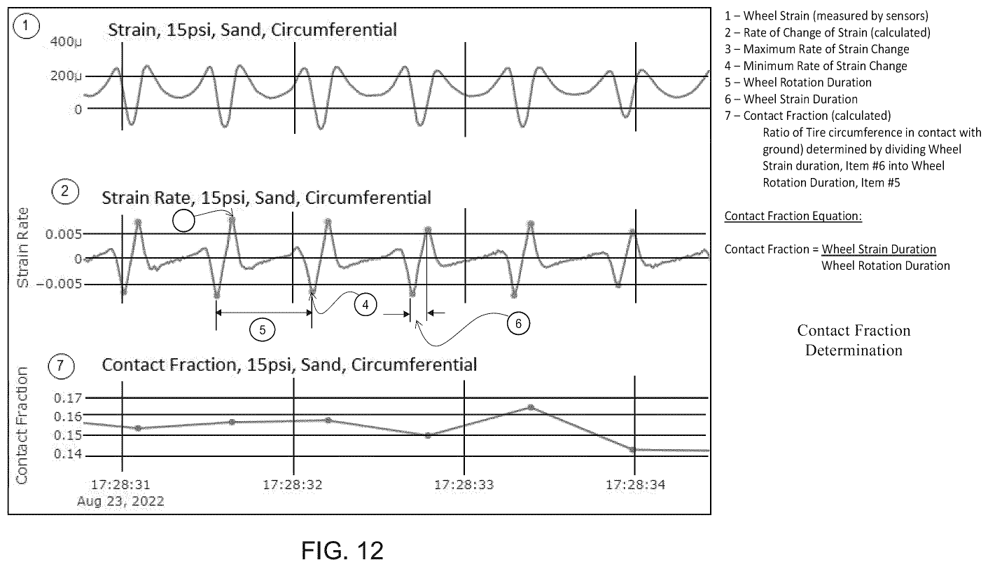

Thereafter, at block 1002, the CTI controller 504 calculates a rate of strain change of each of the plurality of wheels based on the strain measurements. With reference to FIG. 11, when the wheels 200 and tires 300 of a vehicle are positioned on the ground medium 900 to support the vehicle, a first peak wheel strain detection 1100 is made as the tire 300 initially contacts the ground medium 900. A second peak wheel strain detection 1102 is then determined at a point where the tire 300 leaves contact with the ground medium 900. A contact angle 1104 is present between the point where the tire 300 initially contacts the ground medium 900 and the point where the tire 300 leaves contact with the ground medium 900. The portion of the tire 300 circumference in contact with the ground medium 900 is provided between the contact angle 1104 and is denoted by reference numeral 1106. The rate of strain is determined based on the duration of time to change from a minimum strain value to a maximum strain value as denoted by reference numeral 6 in FIG. 12. The CTI controller 504 then determines a maximum rate of strain change and a minimum rate of strain change based on the calculated rate of strain change. More specifically, graph 2 in FIG. 12 illustrates the calculated rate of change of strain determined at block 1002. The X-axis of this graph denotes time and the Y-axis denotes strain rate. In FIG. 12, the maximum rate of strain change is denoted by reference numeral 3 and the minimum rate of strain change is denoted by reference numeral 4.

Returning to FIG. 10, at block 1004, the CTI controller 504 calculates a contact fraction based on the maximum rate of strain change 3 and the minimum rate of strain change 4. The contact fraction is the ratio of tire circumference in contact with the ground. More specifically and with reference to FIG. 12, the maximum rate of strain change 3 and the minimum rate of strain change 4 are used to determine wheel rotation duration 5 and wheel strain duration 6. Wheel rotation duration 5 is determined by measuring the time taken from a first minimum rate of strain change 4 determination to a second minimum rate of strain change 4 determination. Wheel strain duration 6 is determined by measuring the time taken from a minimum rate of change 4 determination to an adjacent maximum rate of strain change 3 determination. Contact fraction is then determined by dividing wheel strain duration into wheel rotation duration as shown by the following Equation (3).

$$Contact Fraction = \frac{Wheel Strain Duration}{Wheel Rotation Duration} \qquad ( 3 )$$

For example, Graph 7 in FIG. 12 illustrates an example calculated contact fraction over time.

Returning to FIG. 10, the CTI controller 504 may use the calculated contact fraction to estimate a contact area for each of the plurality of tires 300. The estimated contact area for each of the plurality of tires 300 may be displayed on the user interface/display 506. Alternatively, or additionally, the estimated contact area for each of the plurality of tires 300 may be utilized by the CTI controller 504 to control the vehicle CTI system 500 and the CTI valve 224 (e.g., via vehicle CAN bus 505, etc.) to inflate or deflate the tire 300 positioned on each of the plurality of wheels 200. For example, CTI controller 504 may use a tire pressure improvement or optimization algorithm 1300 as described herein to determine a pressure at which each of the tires 300 of each of the wheels 200 should be inflated or deflated and control the CTI system 500 to inflate or deflate each of the tires 300 of each of the wheels 200 to the determined pressure for that tire 300.

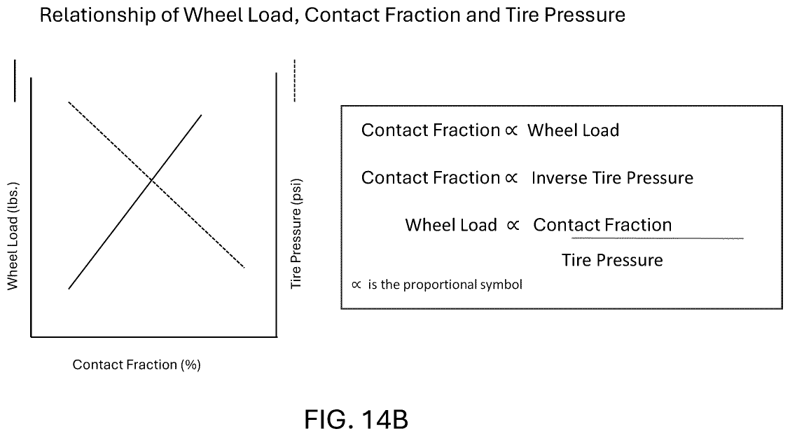

With reference to FIG. 14A, the contact fraction for each of the wheels 200 may be used to estimate a relative load on each of the wheels 200. For example, at block 1400, the CTI controller 504 calculates the contact fraction for each wheel 200 based on strain rate as discussed herein above with reference to FIGS. 10-12. Thereafter, the CTI controller 504, at block 1402, compares the contact fractions for each wheel 200 to determine a relative contact fraction between the wheels. The CTI controller 504 may be configured to estimate according to a relationship of wheel load, contact fraction, and tire pressure as illustrated in FIG. 14B, a relative load on each wheel, at block 1404, based on tire pressure measurements from the pressure sensor 110 of the sensor assembly 100 and the relative contact fraction. The estimated relative load on each wheel may be displayed on the user interface/display 506 or a warning to centralize the load may be displayed on the user interface/display 506. Alternatively, or in addition to, the estimated relative load on each wheel may be utilized by the CTI controller 504 to control the vehicle CTI system 500 and the CTI valve 224 (e.g., via vehicle CAN bus 505, etc.) to inflate or deflate the tire 300 positioned on each of the plurality of wheels 200. For example, CTI controller 504 may use a tire pressure improvement or optimization algorithm 1300 as described herein to determine a pressure at which each of the tires 300 of each of the wheels 200 should be inflated or deflated and control the CTI system 500 to inflate or deflate each of the tires 300 of each of the wheels 200 to the determined pressure for that tire 300.

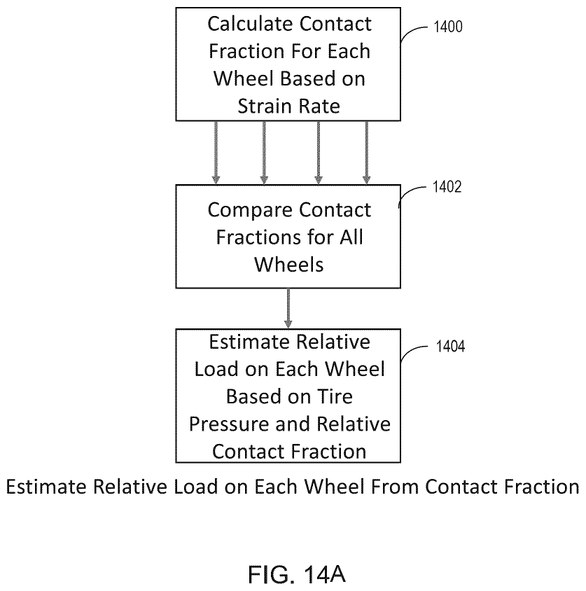

With reference to FIG. 13, the system may be utilized to adjust and maintain tire pressure based on inputs of pressure and temperature. For example, a tire pressure improvement or optimization algorithm 1300 may be implemented by the CTI controller 504. The CTI controller 504 may be “hard-coded” with instructions to perform the tire pressure improvement or optimization algorithm 1300 or any of the other corresponding function(s) according to aspects described herein. Alternatively, the CTI controller 504 may access an internal and/or external memory to retrieve instructions stored in the memory, which when executed by the CTI controller 504, perform the tire pressure improvement or optimization algorithm 1300 or any of the other corresponding function(s) associated with the CTI controller 504, and/or one or more functions and/or operations related to the operation of a component having the CTI controller 504 included therein. The memory may be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

The tire pressure improvement or optimization algorithm 1300 may receive, as input, a current vehicle velocity 1302, a current wheel angular velocity, various vehicle properties 1304, such as a vehicle weight, a vehicle load distribution, a tire size (e.g., a tire circumference, etc.), a tire tread width, etc., a current tire pressure and temperature 1306 as determined by the pressure sensor 110 and the temperature sensor 112 of the sensor assembly 100, a contact fraction 1308 of the wheels 200 as discussed hereinabove with reference to FIGS. 10-12, a relative load on each wheel as discussed herein above with reference to FIGS. 14A and 14B, an amount of tire slip or wheel slip ratio as described hereinabove with reference to FIGS. 8-9, or any combination thereof. Based on this information, the tire pressure improvement or optimization algorithm 1300 may determine the improved or optimal pressure at which each of the tires 300 of each of the wheels 200 should be inflated or deflated. This information may be utilized by the CTI controller 504 to control the vehicle CTI system 500 and the CTI valve 224 to inflate or deflate the tire 300 positioned on each of the plurality of wheels 200 to the improved or optimal pressure determined for that tire 300. In some non-limiting embodiments or aspects, the tire pressure improvement or optimization algorithm 1300 may determine the improved or optimal pressure at which each of the tires 300 of each of the wheels 200 should be inflated or deflated according to the following Equation (4):

$$Tire Pressure = \frac{Wheel Load}{Contact Fraction \times Tire Circumference \times Tread Width}$$

For example, for a vehicle with a tire circumference of 106.75 inches, a tread with of 12 inches, a wheel load of 10,000 pounds, and a contact fraction of 18%, the tire pressure improvement or optimization algorithm 1300 may determine the improved or optimal pressure at which each of the tires 300 of each of the wheels 200 should be inflated or deflated as 43 psi.

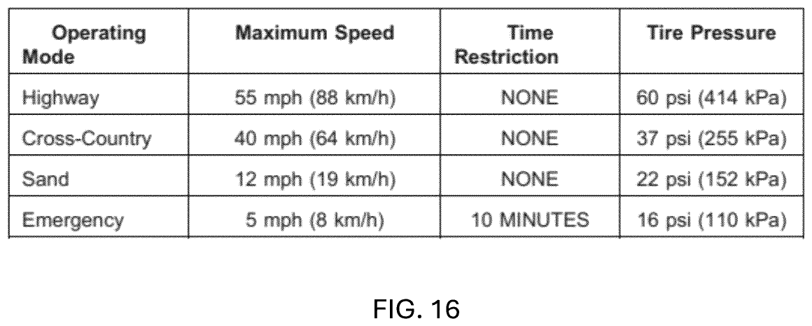

In some non-limiting embodiments or aspects, the tire pressure improvement or optimization algorithm 1300 may determine the improved or optimal pressure at which each of the tires 300 of each of the wheels 200 should be inflated or deflated according to example operating modes and parameters for central tire inflation (CTI) system equipped vehicles as illustrated in the table of FIG. 16.

In some implementations, the tire pressure improvement or optimization algorithm 1300 may include providing a current vehicle velocity 1302, a current wheel angular velocity, various vehicle properties 1304, such as a vehicle weight, a vehicle load distribution, a tire size (e.g., a tire circumference, etc.), a tire tread width, etc., a current tire pressure and temperature 1306 as determined by the pressure sensor 110 and the temperature sensor 112 of the sensor assembly 100, a contact fraction 1308 of the wheels 200 as discussed hereinabove with reference to FIGS. 10-12, a relative load on each wheel as discussed herein above with reference to FIGS. 14A and 14B, an amount of tire slip or wheel slip ratio as described hereinabove with reference to FIGS. 8-9, or any combination thereof to at least one machine learning model trained using at least one machine learning algorithm or other artificial intelligence techniques to accept a current vehicle velocity 1302, a current wheel angular velocity, various vehicle properties 1304, such as a vehicle weight, a vehicle load distribution, a tire size (e.g., a tire circumference, etc.), a tire tread width, etc., a current tire pressure and temperature 1306 as determined by the pressure sensor 110 and the temperature sensor 112 of the sensor assembly 100, a contact fraction 1308 of the wheels 200 as discussed hereinabove with reference to FIGS. 10-12, a relative load on each wheel as discussed herein above with reference to FIGS. 14A and 14B, an amount of tire slip or wheel slip ratio as described hereinabove with reference to FIGS. 8-9, or any combination thereof as input(s) and provide an improved or optimal pressure at which each of the tires 300 of each of the wheels 200 should be inflated or deflated as an output. For example, the CTI controller 504 may process a current vehicle velocity 1302, a current wheel angular velocity, various vehicle properties 1304, such as a vehicle weight, a vehicle load distribution, a tire size (e.g., a tire circumference, etc.), a tire tread width, etc., a current tire pressure and temperature 1306 as determined by the pressure sensor 110 and the temperature sensor 112 of the sensor assembly 100, a contact fraction 1308 of the wheels 200 as discussed hereinabove with reference to FIGS. 10-12, a relative load on each wheel as discussed herein above with reference to FIGS. 14A and 14B, an amount of tire slip or wheel slip ratio as described hereinabove with reference to FIGS. 8-9, or any combination thereof to determine an improved or optimal pressure at which each of the tires 300 of each of the wheels 200 should be inflated or deflated by providing, as input to a machine learning model the current vehicle velocity 1302, the current wheel angular velocity, various vehicle properties 1304, such as the vehicle weight, the vehicle load distribution, the tire size (e.g., a tire circumference, etc.), the tire tread width, etc., the current tire pressure and temperature 1306 as determined by the pressure sensor 110 and the temperature sensor 112 of the sensor assembly 100, the contact fraction 1308 of the wheels 200 as discussed hereinabove with reference to FIGS. 10-12, the relative load on each wheel as discussed herein above with reference to FIGS. 14A and 14B, the amount of tire slip or wheel slip ratio as described hereinabove with reference to FIGS. 8-9, or any combination thereof; and receiving, as output from the machine learning model, the improved or optimal pressure at which each of the tires 300 of each of the wheels 200 should be inflated or deflated.

Aspects described include artificial intelligence or other operations whereby the system processes inputs and generates outputs with apparent intelligence. The artificial intelligence may be implemented in whole or in part by a model. A model may be implemented as a machine learning model. The learning may be supervised, unsupervised, reinforced, or a hybrid learning whereby multiple learning techniques are employed to generate the model. The learning may be performed as part of training. Training the model may include obtaining a set of training data and adjusting characteristics of the model to obtain a desired model output. For example, three characteristics may be associated with a desired item location. In such instance, the training may include receiving the three characteristics as inputs to the model and adjusting the characteristics of the model such that for each set of three characteristics, the output device state matches the desired device state associated with the historical data.

In some implementations, the training may be dynamic. For example, the system may update the model using a set of events. The detectable properties from the events may be used to adjust the model.

The model may be an equation, artificial neural network, recurrent neural network, convolutional neural network, decision tree, or other machine-readable artificial intelligence structure. The characteristics of the structure available for adjusting during training may vary based on the model selected. For example, if a neural network is the selected model, characteristics may include input elements, network layers, node density, node activation thresholds, weights between nodes, input or output value weights, or the like. If the model is implemented as an equation (e.g., regression), the characteristics may include weights for the input parameters, thresholds, or limits for evaluating an output value, or criterion for selecting from a set of equations.

Once a model is trained, retraining may be included to refine or update the model to reflect additional data or specific operational conditions. The retraining may be based on one or more signals detected by a device described herein or as part of a method described herein. Upon detection of the designated signals, the system may activate a training process to adjust the model as described.

Further examples of machine learning and modeling features which may be included in the embodiments discussed above are described in “A survey of machine learning for big data processing” by Qiu et al. in EURASIP Journal on Advances in Signal Processing (2016) which is hereby incorporated by reference in its entirety.

Although the disclosed subject matter has been described in detail for the purpose of illustration based on what is currently considered to be the most practical and preferred embodiments, it is to be understood that such detail is solely for that purpose and that the disclosed subject matter is not limited to the disclosed embodiments, but, on the contrary, is intended to cover modifications and equivalent arrangements that are within the spirit and scope of the appended claims. For example, it is to be understood that the presently disclosed subject matter contemplates that, to the extent possible, one or more features of any embodiment can be combined with one or more features of any other embodiment.

What is claimed is:

1. A system for monitoring wheel performance of a vehicle, the vehicle including a plurality of wheels and a plurality of tires mounted on the plurality of wheels, the system comprising:
a plurality of sensors on the plurality of wheels;
a controller operatively connected to the plurality of sensors, the controller including at least one processor configured to:
receive, for each wheel of the plurality of wheels, from a sensor of the plurality of sensors on that wheel, a strain measurement associated with that wheel;
calculate, for each wheel of the plurality of wheels, based on the strain measurement associated with that wheel, a rate of strain change of that wheel;
determine, for each wheel of the plurality of wheels, based on the rate of strain change, a maximum rate of strain change of that wheel and a minimum rate of strain change of that wheel;
calculate, for each wheel of the plurality of wheels, based on the maximum rate of strain change and the minimum rate of strain change, a contact fraction of that wheel;
estimate, for each wheel of the plurality of wheels, based on the contact fraction of that wheel, a contact area of a tire mounted on that wheel; and
perform at least one of the following: (i) control a display to display the amount of contact area of at least one tire of the plurality of tires, (ii) control a central tire inflation system of the vehicle to inflate or deflate the at least one tire of the plurality of tires based on the contact area of the at least one tire, or any combination thereof.

2. The system of claim 1, further comprising:
a plurality of central tire inflation valves associated with the plurality of wheels;
the central tire inflation system fluidically coupled to the plurality of wheels via a plurality of fluid lines and the plurality of central tire inflation valves.

3. The system of claim 1, wherein the plurality of sensors includes a plurality of strain gauges.

4. The system of claim 1, wherein the strain measurements are obtained by performing at least one of the following: measuring a strain on a wheel using a strain gauge provided directly on the wheel; measuring the strain on the wheel through an intermediary component attached to the wheel with the strain gauge mounted to the intermediary component; measuring the strain on the wheel using a bonded piezoelectric material; measuring a compressive load between a rim of the wheel and a tire bead of a tire mounted on the wheel, or any combination thereof.

5. The system of claim 1, wherein the controller is operatively connected to each sensor of the plurality of sensors in one of a wireless configuration or a wired configuration.

6. The system of claim 4, wherein a wheel of the plurality of wheels includes a circular rim having formed coaxially on opposite ends thereof outwardly flaring circumferential flange sections disposed to be engaged by beads of the tire mounted on the rim, wherein the rim further includes intermediate the opposite ends thereof a transverse wall section extending transversely of an axis of the rim, and having therethrough a central opening disposed coaxially of the axis, and wherein the central tire inflation valve is secured to a side of the transverse wall section and includes a pair of air inlet/outlet ducts.

7. The system of claim 1, wherein a wheel of the plurality of wheels includes a two-piece wheel, and wherein the two-piece wheel includes an inner rim half and an outer rim half held together with fastening members.

8. The system of claim 1, wherein the controller including at least one processor is further configured to:
estimate, based on the contact fraction of each wheel of the plurality of wheels and a current tire pressure of each wheel of the plurality of wheels, a relative load on each wheel of the plurality of wheels; and
perform at least one of the following: (i) control a display to display the relative load on each wheel of the plurality of wheels, (ii) control the central tire inflation system of the vehicle to inflate or deflate the at least one tire of the plurality of tires based on the relative load on each wheel of the plurality of wheels, or any combination thereof.

9. A method for monitoring wheel performance of a vehicle, the vehicle including a plurality of wheels, a plurality of tires mounted on the plurality of wheels, and a plurality of sensors on the plurality of wheels, the method comprising:
receiving, with at least one processor, for each wheel of the plurality of wheels, from a sensor of the plurality of sensors on that wheel, a strain measurement associated with that wheel;
calculating, with the at least one processor, for each wheel of the plurality of wheels, based on the strain measurement associated with that wheel, a rate of strain change of that wheel;
determining, with the at least one processor, for each wheel of the plurality of wheels, based on the rate of strain change, a maximum rate of strain change of that wheel and a minimum rate of strain change of that wheel;
calculating, with the at least one processor, for each wheel of the plurality of wheels, based on the maximum rate of strain change and the minimum rate of strain change, a contact fraction of that wheel;
estimating, with the at least one processor, for each wheel of the plurality of wheels, based on the contact fraction of that wheel, a contact area of a tire mounted on that wheel; and
performing, with the at least one processor, at least one of the following: (i) controlling a display to display the amount of contact area of at least one tire of the plurality of tires, (ii) controlling a central tire inflation system of the vehicle to inflate or deflate the at least one tire of the plurality of tires based on the contact area of the at least one tire, or any combination thereof.

10. The method of claim 9, wherein the central tire inflation system is fluidically coupled to the plurality of wheels via a plurality of fluid lines and a plurality of central tire inflation valves associated with the plurality of wheels.

11. The method of claim 9, wherein the plurality of sensors includes a plurality of strain gauges.

12. The method of claim 9, wherein the strain measurements are obtained by performing at least one of the following: measuring a strain on a wheel using a strain gauge provided directly on the wheel; measuring the strain on the wheel through an intermediary component attached to the wheel with the strain gauge mounted to the intermediary component; measuring the strain on the wheel using a bonded piezoelectric material; measuring a compressive load between a rim of the wheel and a tire bead of a tire mounted on the wheel, or any combination thereof.

13. The method of claim 9, wherein a controller including the at least one processor is operatively connected to each sensor of the plurality of sensors in one of a wireless configuration or a wired configuration.

14. The method of claim 12, wherein a wheel of the plurality of wheels includes a circular rim having formed coaxially on opposite ends thereof outwardly flaring circumferential flange sections disposed to be engaged by beads of the tire mounted on the rim, wherein the rim further includes intermediate the opposite ends thereof a transverse wall section extending transversely of an axis of the rim, and having therethrough a central opening disposed coaxially of the axis, and wherein the central tire inflation valve is secured to a side of the transverse wall section and includes a pair of air inlet/outlet ducts.

15. The method of claim 9, wherein a wheel of the plurality of wheels includes a two-piece wheel, and wherein the two-piece wheel includes an inner rim half and an outer rim half held together with fastening members.

16. The method of claim 9, further comprising:
estimating, with the at least one processor, based on the contact fraction of each wheel of the plurality of wheels and a current tire pressure of each wheel of the plurality of wheels, a relative load on each wheel of the plurality of wheels; and
performing, with the at least one processor, at least one of the following: (i) controlling a display to display the relative load on each wheel of the plurality of wheels, (ii) controlling the central tire inflation system of the vehicle to inflate or deflate the at least one tire of the plurality of tires based on the relative load on each wheel of the plurality of wheels, or any combination thereof.

17. A computer program product comprising at least one non-transitory computer-readable medium including program instructions for monitoring wheel performance of a vehicle, the vehicle including a plurality of wheels, a plurality of tires mounted on the plurality of wheels, and a plurality of sensors on the plurality of wheels, that, when executed by at least one processor, cause the at least one processor to:
receive, for each wheel of the plurality of wheels, from a sensor of the plurality of sensors on that wheel, a strain measurement associated with that wheel;
calculate, for each wheel of the plurality of wheels, based on the strain measurement associated with that wheel, a rate of strain change of that wheel;
determine, for each wheel of the plurality of wheels, based on the rate of strain change, a maximum rate of strain change of that wheel and a minimum rate of strain change of that wheel;
calculate, for each wheel of the plurality of wheels, based on the maximum rate of strain change and the minimum rate of strain change, a contact fraction of that wheel;
estimate, for each wheel of the plurality of wheels, based on the contact fraction of that wheel, a contact area of a tire mounted on that wheel; and
perform at least one of the following: (i) control a display to display the amount of contact area of at least one tire of the plurality of tires, (ii) control a central tire inflation system of the vehicle to inflate or deflate the at least one tire of the plurality of tires based on the contact area of the at least one tire, or any combination thereof.

18. The computer program product of claim 17, wherein the central tire inflation system is fluidically coupled to the plurality of wheels via a plurality of fluid lines and a plurality of central tire inflation valves associated with the plurality of wheels.

19. The computer program product of claim 17, wherein the plurality of sensors includes a plurality of strain gauges.

20. The computer program product of claim 17, wherein the strain measurements are obtained by performing at least one of the following: measuring a strain on a wheel using a strain gauge provided directly on the wheel; measuring the strain on the wheel through an intermediary component attached to the wheel with the strain gauge mounted to the intermediary component; measuring the strain on the wheel using a bonded piezoelectric material; measuring a compressive load between a rim of the wheel and a tire bead of a tire mounted on the wheel, or any combination thereof.

21. The computer program product of claim 17, wherein a controller including the at least one processor is operatively connected to each sensor of the plurality of sensors in one of a wireless configuration or a wired configuration.

22. The computer program product of claim 20, wherein a wheel of the plurality of wheels includes a circular rim having formed coaxially on opposite ends thereof outwardly flaring circumferential flange sections disposed to be engaged by beads of the tire mounted on the rim, wherein the rim further includes intermediate the opposite ends thereof a transverse wall section extending transversely of an axis of the rim, and having therethrough a central opening disposed coaxially of the axis, and wherein the central tire inflation valve is secured to a side of the transverse wall section and includes a pair of air inlet/outlet ducts.

23. The computer program product of claim 17, wherein a wheel of the plurality of wheels includes a two-piece wheel, and wherein the two-piece wheel includes an inner rim half and an outer rim half held together with fastening members.

24. The computer program product of claim 17, wherein the program instructions, when executed by the at least one processor, further causer the at least one processor to:
estimate, based on the contact fraction of each wheel of the plurality of wheels and a current tire pressure of each wheel of the plurality of wheels, a relative load on each wheel of the plurality of wheels; and
perform at least one of the following: (i) controlling a display to display the relative load on each wheel of the plurality of wheels, (ii) controlling the central tire inflation system of the vehicle to inflate or deflate the at least one tire of the plurality of tires based on the relative load on each wheel of the plurality of wheels, or any combination thereof.
